(19) United States
(12) Patent Application Publication
(10) Pub. No.: US 2018/0121824 A1
(43) Pub. Date: May 3, 2018

(54) Artificial Intelligence for Decision Making Based on Machine Learning of Human Decision Making Process

(71) Applicant: Dreamsquare Inc., San Jose, CA (US)

(72) Inventors: Shin Hwan Han, Seongnam-si (KR); Sanghyun Park, Sunnyvale, CA (US); Jungho JEON, Seoul (KR)

(21) Appl. No.: 15/281,005

(22) Filed: Sep. 29, 2016

Related U.S. Application Data
(63) Continuation-in-part of application No. 14/498,859, filed on Sep. 26, 2014, now Pat. No. 9,773,066.

(51) Int. Cl. G06N 99/00; G06F 17/30

(52) U.S. Cl. CPC G06N 99/005; G06F 17/30412; G06F 17/30592

(57) ABSTRACT

A computer system access in a database a first linear sequence table including a plurality of entries. A respective entry of the plurality of entries includes sequential state information for a respective user. The sequential state information for the respective entry identifies a respective preceding event associated with a respective preceding time and a respective subsequent event associated with a respective subsequent time that is subsequent to the respective preceding time. The computer system initiates aggregation of data in the first linear sequence table to obtain a quantity that corresponds to a number of entries that are associated with a particular preceding event and a particular subsequent event of preceding events and subsequent events of the plurality of entries.

### RELATED APPLICATION

This application is related to U.S. patent application Ser. No. 14/498,859, filed Sep. 26, 2014, which is incorporated by reference herein in its entirety.

### TECHNICAL FIELD

This application relates generally to data processing for artificial intelligence, and in particular, to data processing in artificial intelligence for decision making based on machine learning of human decision making process in large-scale data (also called herein “big data”).

### BACKGROUND

Advances in artificial intelligence technologies promise automation in a vast array of applications. One of the key areas in artificial intelligence technologies is to learn from and mimic human decision making processes. Although the increased affordability of fast computers has improved machine learning based on statistical analysis of large data, machine learning takes a significant amount of time and resources.

### SUMMARY

Accordingly, there is a need for faster and more effective methods and systems for machine learning of human decision making processes. Such methods and systems optionally complement or replace conventional methods for machine learning of human decision making processes.

In accordance with some embodiments, a method is performed at a computer system with one or more processors and memory. The method includes crawling a plurality of web pages, a respective web page containing biographical information of a respective person; parsing the crawled information into state events and determining causality between any two of the state events; storing the state events and the causality in a database; and, subsequent to storing the state events and the causality in the database, receiving a first request from a user to determine a path to a target state. The target state includes a target state event. The method also includes, in response to receiving the first request, obtaining a current state of the user. The current state of the user includes one or more state events associated with the user. The method further includes, determining one or more paths from the current state of the user to the target state based on the current state of the user and the state events and the causality stored in the database, including identifying one or more recommended state events, each recommended state event of the one or more recommended state events having a causality value for the target state that satisfies first preselected causality criteria; and providing at least one path from the current state of the user to the target state.

In accordance with some embodiments, a method is performed at a computer system with one or more processors and memory. The method includes accessing in a database a first linear sequence table including a plurality of entries. A respective entry of the plurality of entries includes sequential state information for a respective user. The sequential state information for the respective entry identifies a respective preceding event associated with a respective preceding time and a respective subsequent event associated with a respective subsequent time that is subsequent to the respective preceding time. The method also includes initiating aggregation of data in the first linear sequence table to obtain a quantity that corresponds to a number of entries that are associated with a particular preceding event and a particular subsequent event of preceding events and subsequent events of the plurality of entries.

In accordance with some embodiments, a method is performed at a computer system with one or more processors and memory. The method includes accessing in a database a first table including a plurality of entries. A respective entry of the plurality of entries includes state information and sequence information for a respective user. The state information for the respective entry identifies a respective event associated with the respective user and the sequence information for the respective entry identifying a sequence of the respective event within a plurality of events associated with the respective user. The plurality of entries includes multiple entries for the respective user. The method also includes accessing in the database a second table that corresponds to the first table, and filling a first linear sequence table based on entries in the first table and the second table. The first linear sequence table includes a plurality of entries. A respective entry of the plurality of entries of the first linear sequence table includes sequential state information for a particular user. The sequential state information for the respective entry identifies a respective preceding event associated with a respective preceding time and a respective subsequent event associated with a respective subsequent time that is subsequent to the respective preceding time. The method further includes initiating aggregation of data in the first linear sequence table to obtain a quantity that corresponds to a number of users who are associated with a particular preceding event and a particular subsequent event.

In accordance with some embodiments, a computer system includes one or more processors; and memory storing one or more programs for execution by the one or more processors. The one or more programs including instructions for performing any of the methods described above. In accordance with some embodiments, a computer readable storage medium stores one or more programs for execution by one or more processors of a computer system. The one or more programs including instructions for performing any of the methods described above.

Thus, computer systems with large databases of biographical information are provided with more effective methods for collecting and analyzing the biographical information, thereby increasing the effectiveness and user satisfaction with such computer systems. Such methods may complement or replace conventional methods for collecting and analyzing biographical information.

### BRIEF DESCRIPTION OF THE DRAWINGS

For a better understanding of the disclosed embodiments, reference should be made to the Description of Embodiments below, in conjunction with the following drawings in which like reference numerals refer to corresponding parts throughout the figures.

FIG. 1 is a block diagram illustrating an exemplary network architecture of a data processing system in accordance with some embodiments.

FIG. 2 is a block diagram illustrating an exemplary data processing system in accordance with some embodiments.

FIG. 3 is a block diagram illustrating relationships among state events in accordance with some embodiments.

FIGS. 4A-4F illustrate state event data used for analyzing biographical information in accordance with some embodiments.

FIG. 5A-5E are flow diagrams illustrating a method of identifying recommended state events in accordance with some embodiments.

FIG. 6A is a schematic diagram illustrating a method for forming a two-dimensional sequence table in accordance with some embodiments.

FIGS. 6B-6F illustrate a method for forming a linear sequence table in accordance with some embodiments.

FIG. 6G illustrates a multi-dimensional sequence table formed from a linear sequence table in accordance with some embodiments.

FIGS. 7A-7D illustrate methods for using sequence information in accordance with some embodiments.

FIG. 8A-8E are flow diagrams illustrating a method of processing big data in accordance with some embodiments.

### DESCRIPTION OF EMBODIMENTS

A sequence of events is frequently used to understand complex phenomena. For example, if many people, for a given condition, make a same decision, it can be determined that others would, under the same condition, likely make the same decision. Thus, the understanding of human decision making process often requires analysis of sequences of events. However, existing tools are limited in analyzing sequences of events. In particular, when a large amount of data is used, identifying the sequence of inter-related events can be time-consuming and lead to a complex data structure.

For example, with the advancements in communications technologies, and in particular, with the advancements in the Internet technologies, a significant amount of information, which was not imaginable previously, has become available. In particular, people's biographical information (e.g., work history and educational background) can be easily located on the Internet. However, systems and devices for utilizing such information have not been available.

As described below, a computer system analyzes sequential information utilizing novel database operations and structures, which significantly improves the performance of the analysis of sequential information. This allows effective use of “big data,” the computer system is capable of providing more effective and accurate recommendations.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first row could be termed a second row, and, similarly, a second row could be termed a first row, without departing from the scope of the various described embodiments. The first row and the second row are both rows, but they are not the same row.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “user” refers to a person (e.g., a decision maker). In some embodiments, a user does not need to use one or more systems described herein (e.g., the user is not a user of one or more systems described herein).

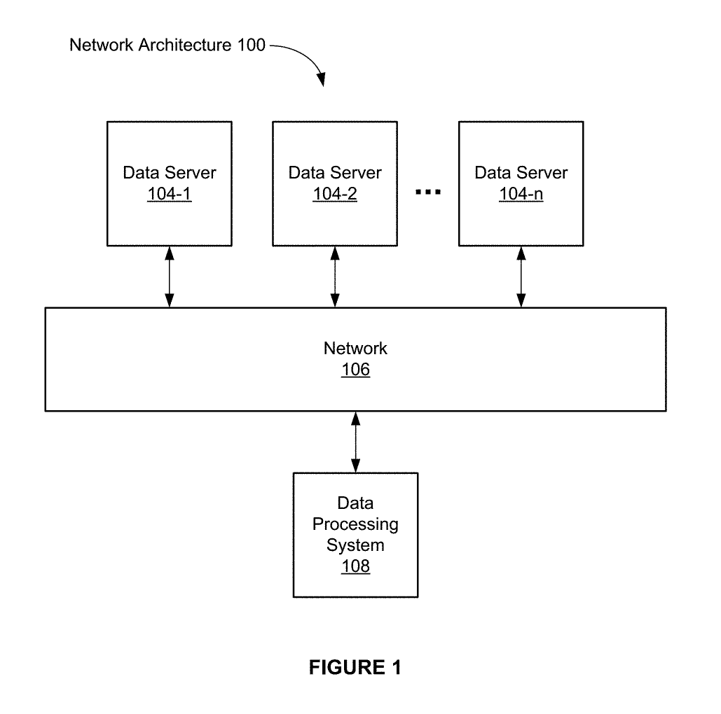

FIG. 1 is a block diagram illustrating an exemplary network architecture of a data processing system in accordance with some embodiments. The network architecture 100 includes a number of data servers 104-1, 104-2, . . . 104-n and a number of client devices (also called “client systems,” “client computers,” or “clients”) (not shown) communicably connected to a data processing system 108 by one or more networks 106.

In some embodiments, the client devices are computing devices, such as laptops and desktop computers, or other appropriate computing devices that can be used to communicate with an electronic data processing system.

In some embodiments, the data servers 104-1, 104-2, . . . 104-n are electronic server systems (e.g., web servers, etc.) configured for providing biographical data.

In some embodiments, the data processing system 108 is a single computing device, such as a computer server, while in other embodiments, the data processing system 108 is implemented by multiple computing devices working together to perform the actions of a server system (e.g., cloud computing).

In some embodiments, the network 106 is a public communication network (e.g., the Internet or a cellular data network), a private communications network (e.g., private LAN or leased lines), or a combination of such communication networks.

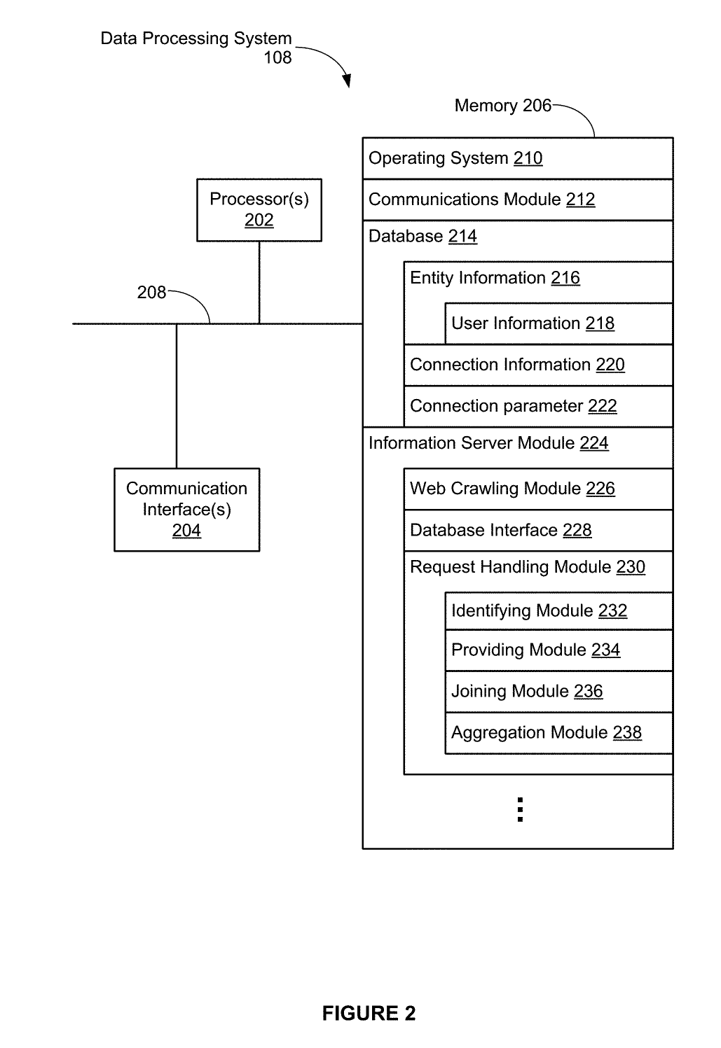

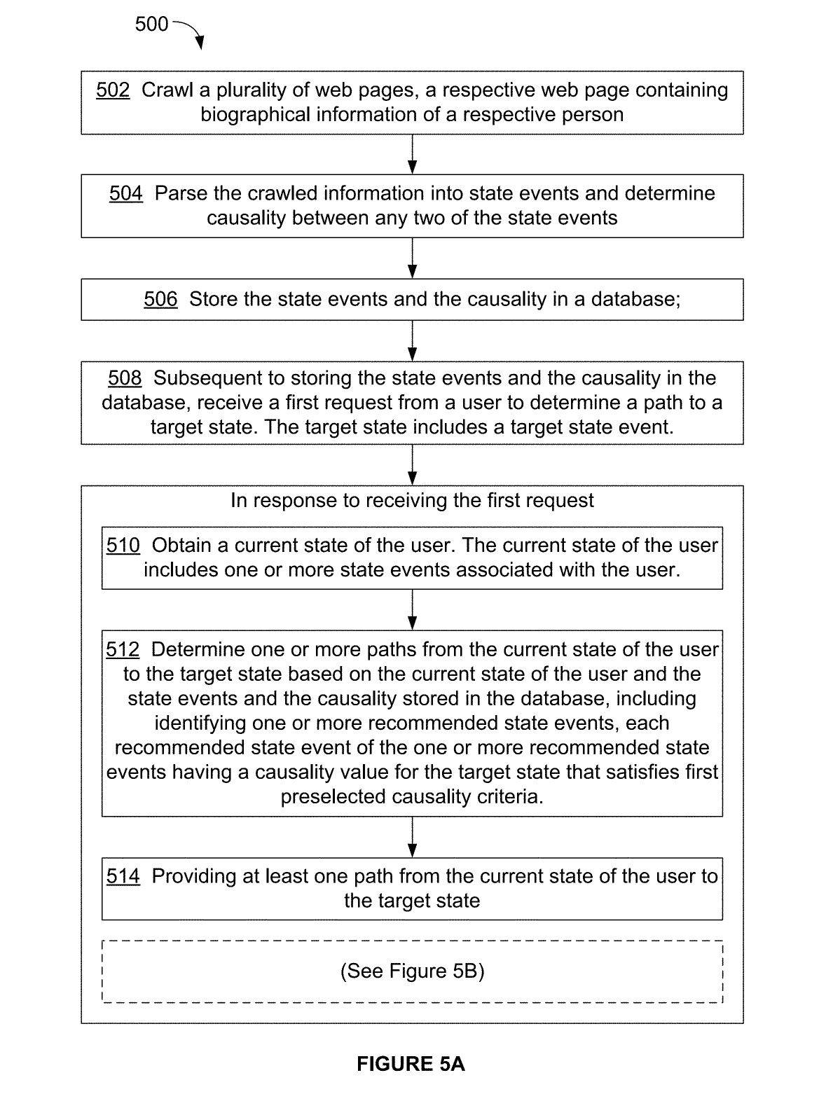

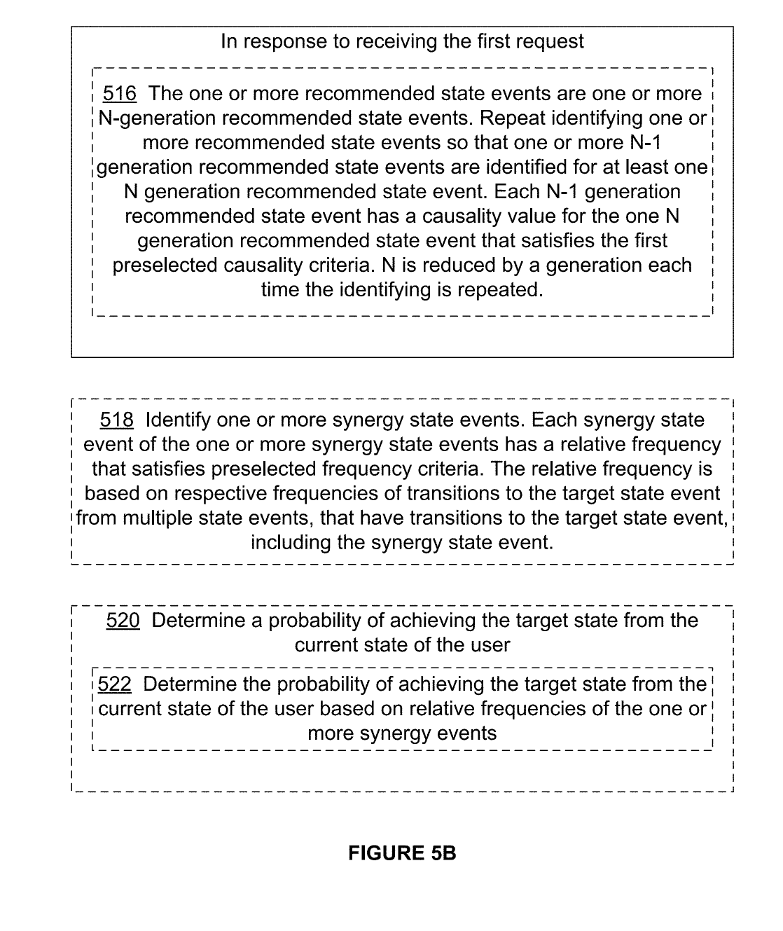

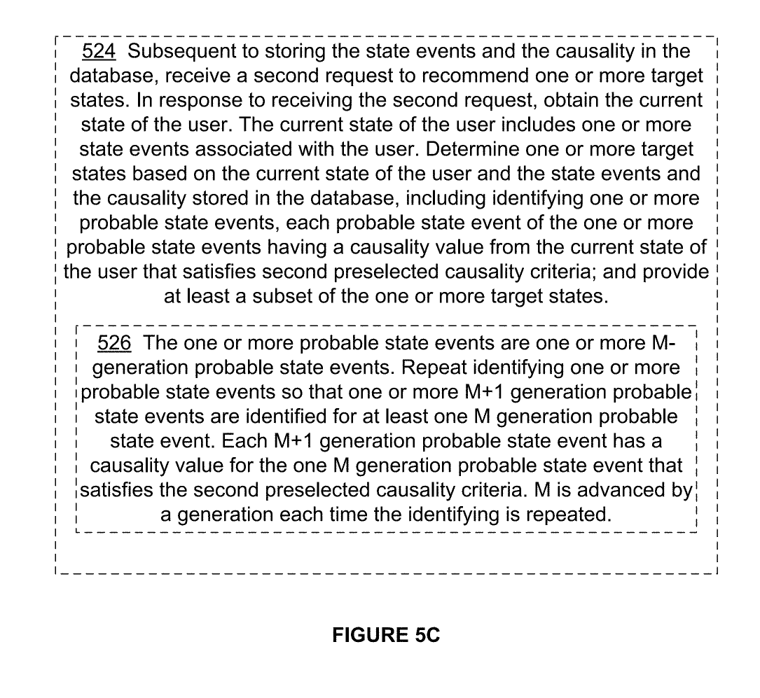

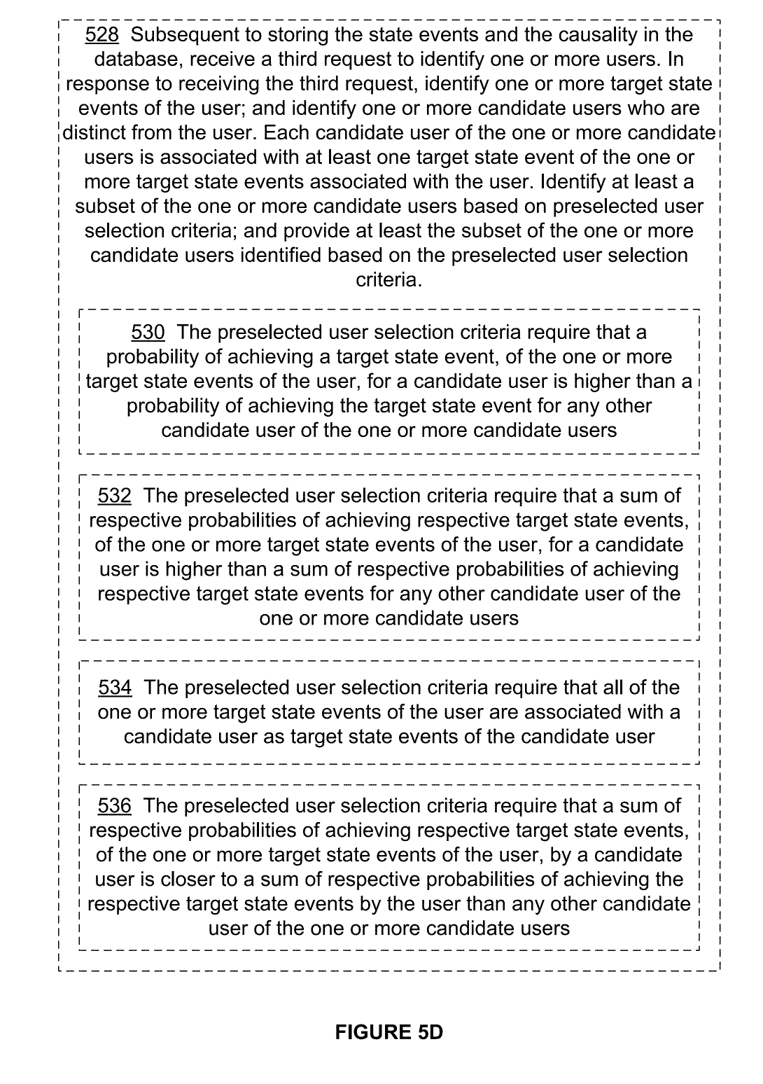

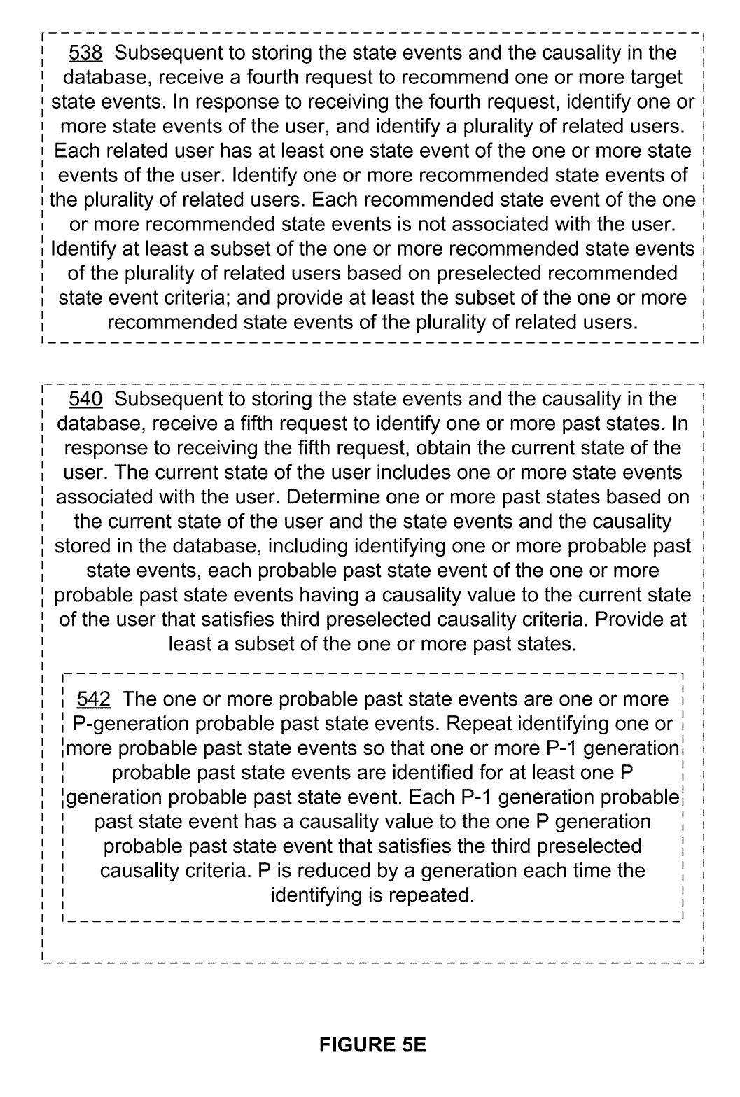

In some embodiments, the data processing system 108 crawls web pages provided by the data servers 104-1 through 104-n and stores crawled information. Further details are provided below with respect to FIG. 2 and FIGS. 5A-5E.

Although FIG. 1 illustrate a data processing system 108 communicating with one or more data servers 104, in some embodiments, the data processing system 108 is separated from the one or more data servers 104 (e.g., the data processing system 108 does not communicate with the one or more data servers 104).

FIG. 2 is a block diagram illustrating an exemplary data processing system 108 in accordance with some embodiments. The data processing system 108 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The data processing system 108 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 206 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the processor(s) 202. Memory 206, or alternately the non-volatile memory device(s) within memory 206, includes a non-transitory computer readable storage medium. In some embodiments, memory 206 or the computer readable storage medium of memory 206 stores the following programs, modules and data structures, or a subset or superset thereof:
an operating system 210 that includes procedures for handling various basic system services and for performing hardware dependent tasks;
a network communication module 212 that is used for connecting the data processing system 108 to other computers via the one or more communication network interfaces 204 (wired or wireless) and one or more communication networks, such as the Internet, cellular telephone networks, mobile data networks, other wide area networks, local area networks, metropolitan area networks, and so on;
a database 214 for storing data associated with information (e.g., biographical information), such as:
   entity information 216, which optionally includes user information 218;
   connection information 220; and
   connection parameter 222; and
an information server module 224, including:
   a web crawling module 226 for crawling web pages;
   a database interface 228, which assists reading data from, and storing data into, a database, such as the database 214; and
   a request handling module 230 for receiving and processing requests (e.g., requests from a client device), including;
      identifying module 232 for identifying one or more state events;
      providing module 234 for outputting results (e.g., sending results to a client device);
      joining module 236 for joining two or more datasets (e.g., tables); and
      aggregation module 238 for aggregating (e.g., selecting, counting, and/or summing) at least a subset of entries in a dataset (e.g., entries that satisfy one or more predefined conditions).

In some embodiments, the database 214 stores entity information 216 (e.g., people's education and work experience) in one or more types of databases, such as graph, dimensional, flat, hierarchical, network, object-oriented, relational, and/or XML databases.

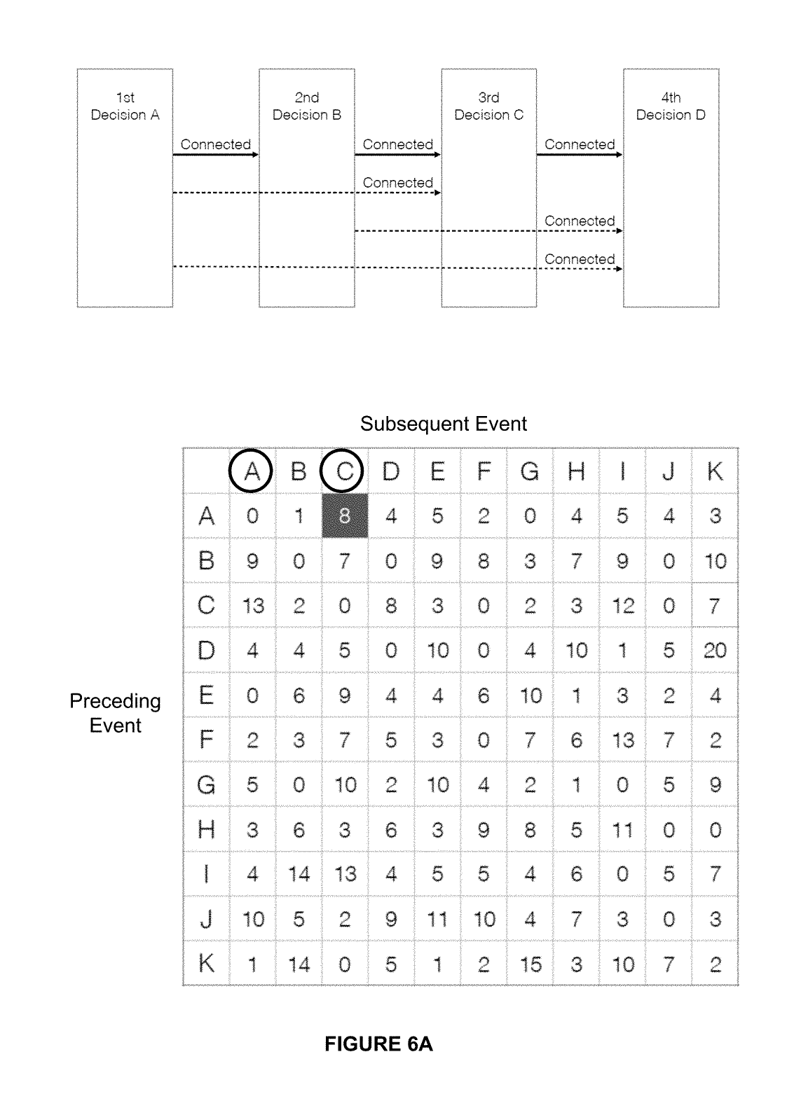

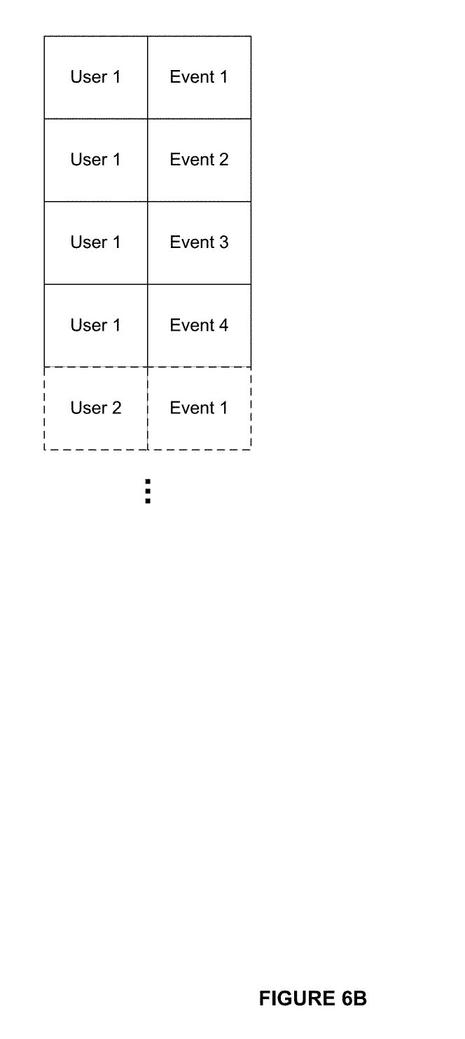

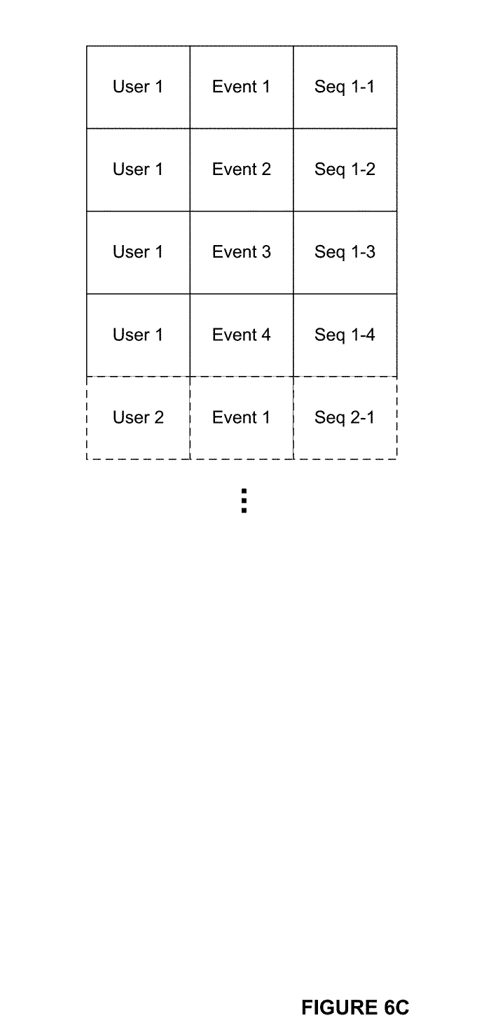

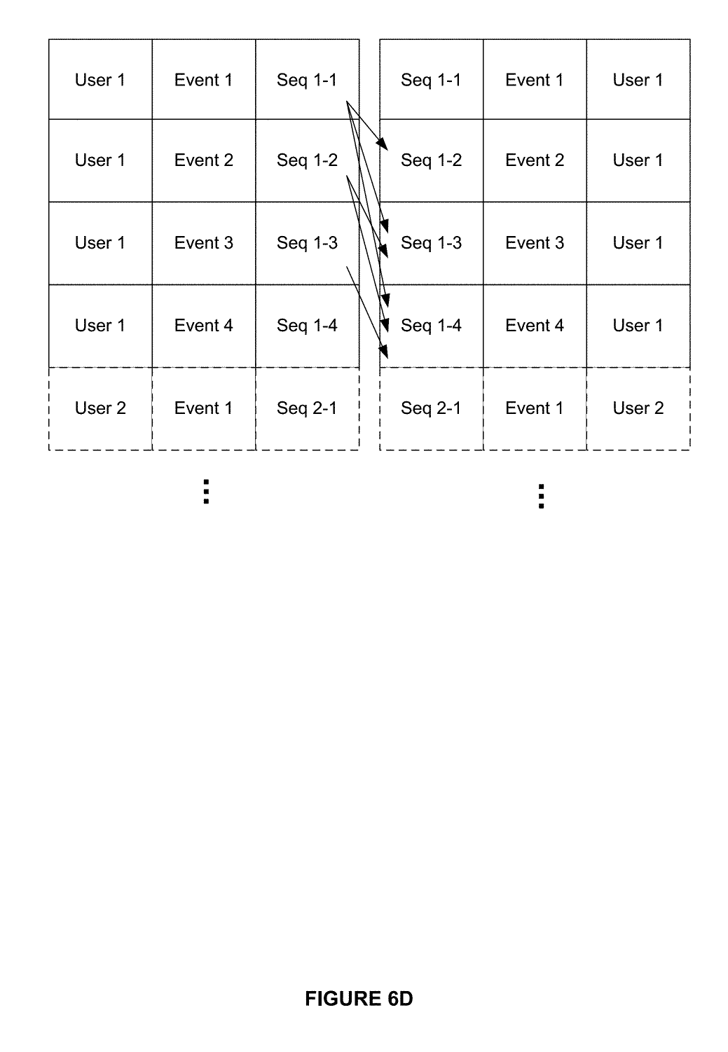

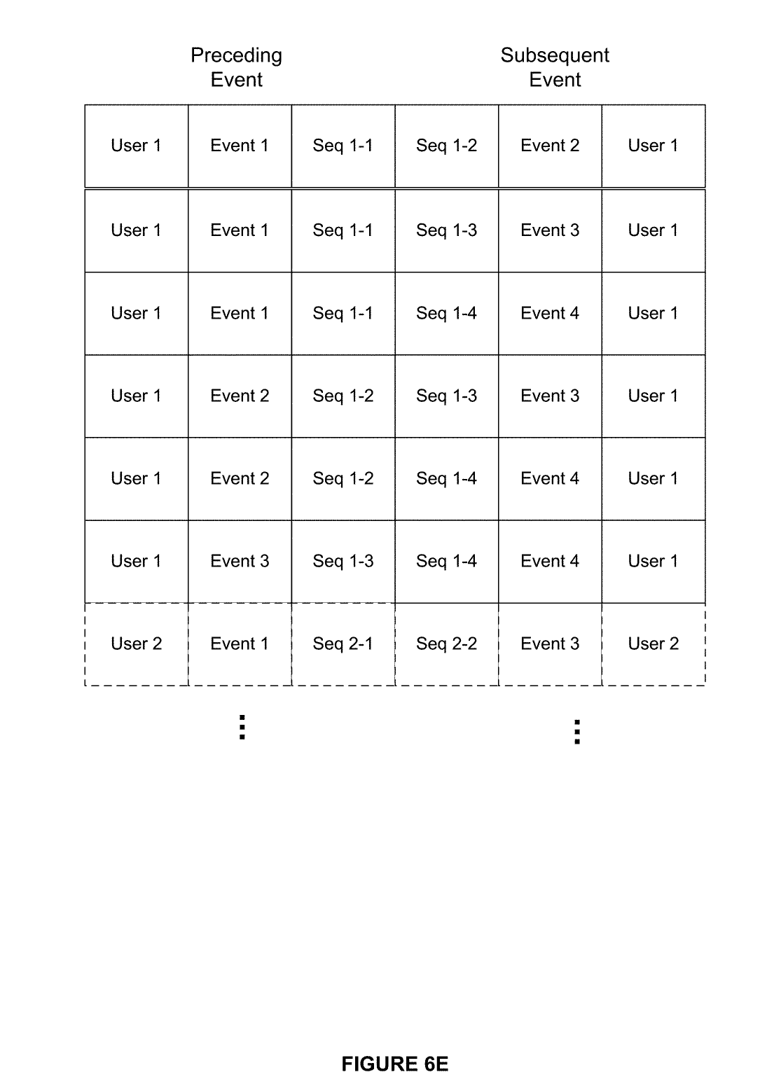

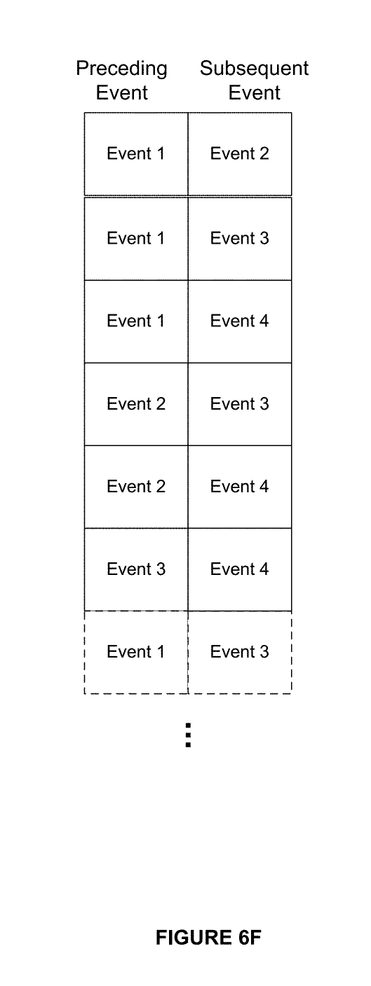

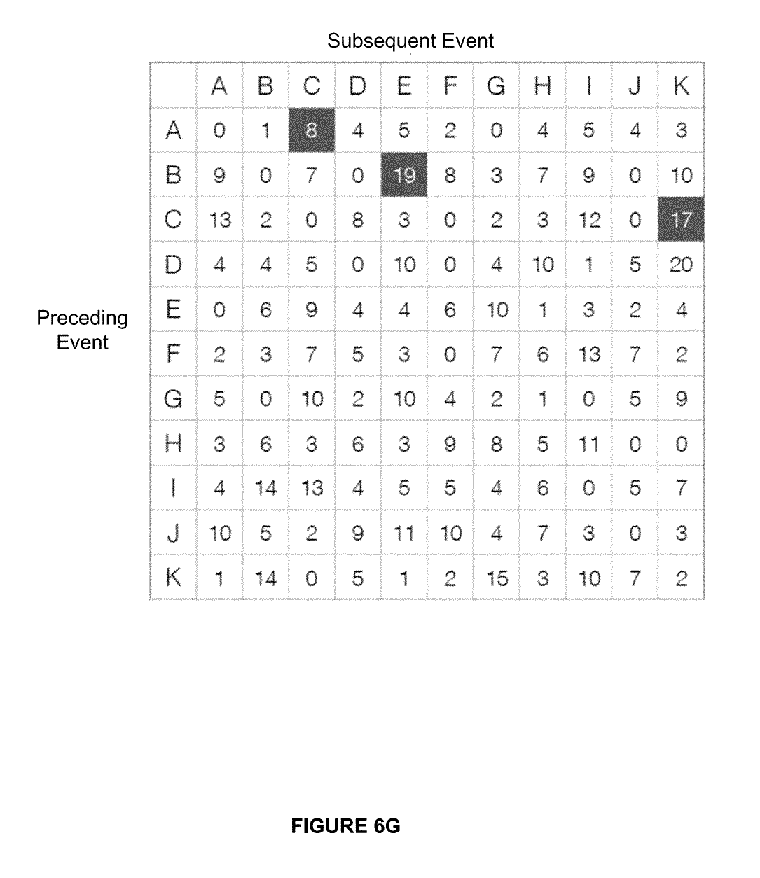

In some embodiments, the database 214 includes a graph database, with entity information 216 represented as nodes in the graph database and connection information 220 represented as edges in the graph database. The graph database includes a plurality of nodes, as well as a plurality of edges that define connections between corresponding nodes. In some embodiments, the nodes and/or edges themselves are data objects that include the identifiers, attributes, and information for their corresponding entities. In some embodiments, the nodes also include pointers or references to other objects, data structures, or resources for use in rendering content in conjunction with the rendering of the pages corresponding to the respective nodes at clients 104. In some embodiments, the database 214 stores information described below with respect to FIGS. 6E-6G.

In some embodiments, entity information 216 includes user information 218, such as user profiles, login information, privacy and other preferences, biographical data, and the like. In some embodiments, for a given user, the user information 218 includes the user's name, anonymized identifier, employment history, education background, target state events (e.g., goals), interests, and/or other information.

In some embodiments, connection information 220 includes information about the relationships between entities in the database 214. In some embodiments, connection information 220 includes information about edges that connect pairs of nodes in a graph database. In some embodiments, an edge connecting a pair of nodes represents a relationship between the pair of nodes.

In some embodiments, connection parameter 222 includes causality values (e.g., transition parameters).

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 206 stores a subset of the modules and data structures identified above. Furthermore, memory 206 optionally stores additional modules and data structures not described above.

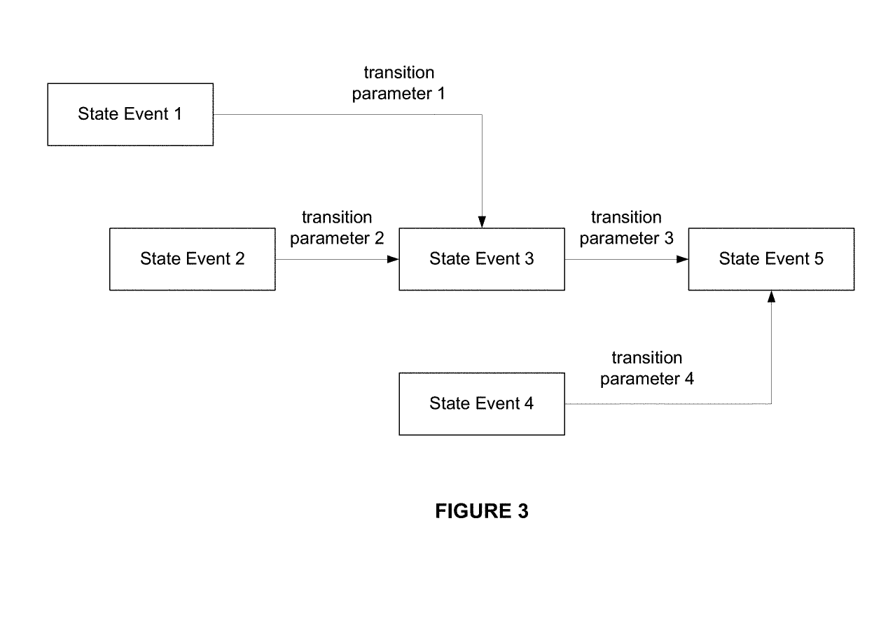

FIG. 3 is a block diagram illustrating relationships among state events in accordance with some embodiments.

In FIG. 3, multiple state events are shown (e.g., State Event 1 through State Event 5). In some embodiments, each state event corresponds to a biographical event (e.g., having a particular job, receiving a particular degree from a school, achieving a career milestone, etc.). In one example, State Event 1 represents receiving a college degree in computer sciences from a particular school, State Event 2 represents (having worked as) an intern at a particular company, State Event 3 represents (having worked as) a software engineer at the particular company, State Event 4 represents completing a management course, and State Event 5 represents (having worked as or working as) a manager at the particular company.

In FIG. 3, State Event 1 is connected with State Event 3. As indicated with a direction of an arrow, State Event 1 has causality to State Event 3, and State Event 3 has causality from State Event 1. Similarly, State Event 2 is connected with State Event 3. Thus, State Event 2 has causality to State Event 3, and State Event 3 has causality from State Event 2. In some embodiments, state events do not need to be directly connected to have causality. For example, State Event 1 has causality to State Event 5 in some embodiments.

In some embodiments, each connection is associated with a causality value (also called herein a transition parameter). FIG. 3 includes multiple transition parameters (e.g., transition parameter 1 through transition parameter 5). In some embodiments, a transition parameter represents a probability of transition. For example, Transition Parameter 1 represents a probability of someone at State Event 1 (having a college degree in computer sciences from a particular school) getting to State Event 3 (becoming a software engineer at the particular company). Transition Parameter 2 represents a probability of someone at State Event 2 (having worked as an intern at the particular company) getting to State Event 3 (becoming a software engineer at the particular company). Transition Parameter 3 represents a probability of someone at State Event 3 (working as a software engineer at the particular company) getting to State Event 5 (becoming a manager at the particular company). Transition Parameter 4 represents a probability of someone at State Event 4 (completing a management class) getting to State Event 5 (becoming a manager at the particular company). In some embodiments, the probability of transition is represented in percentile.

Such state events and their relationships can be obtained from various sources, such as resumes, social network postings, and government websites. In some embodiments, such events and their relationships (e.g., transition parameters) are stored in a database (e.g., a big data database). For example, web pages that include biographical information are collected by crawling, biographical information in the crawled web pages is parsed into state events, and the parsed state events and their relationships are stored in a database. Using data obtained from a large number of web pages (e.g., thousands, tens of thousands, hundreds of thousands, millions, or tens of millions web pages), statistical analysis of the biographical information provides more effective and accurate results.

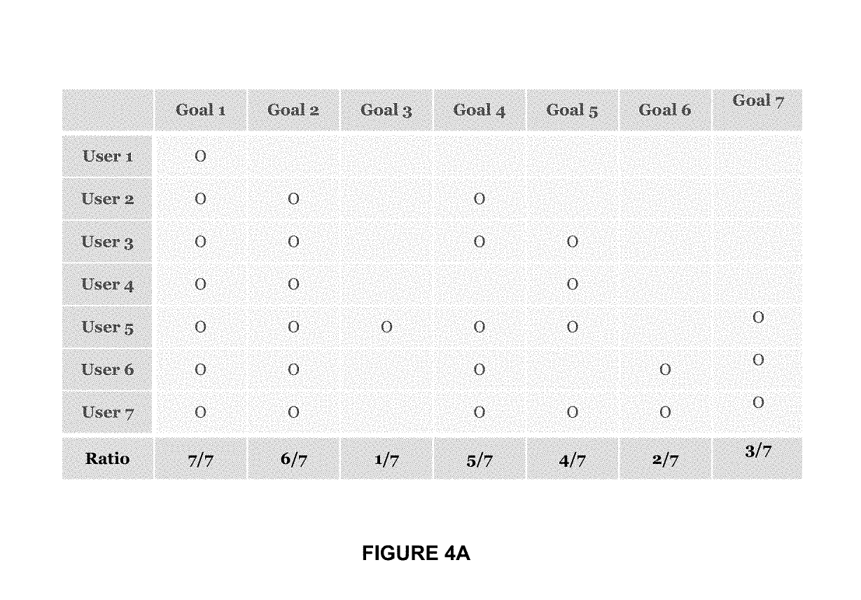

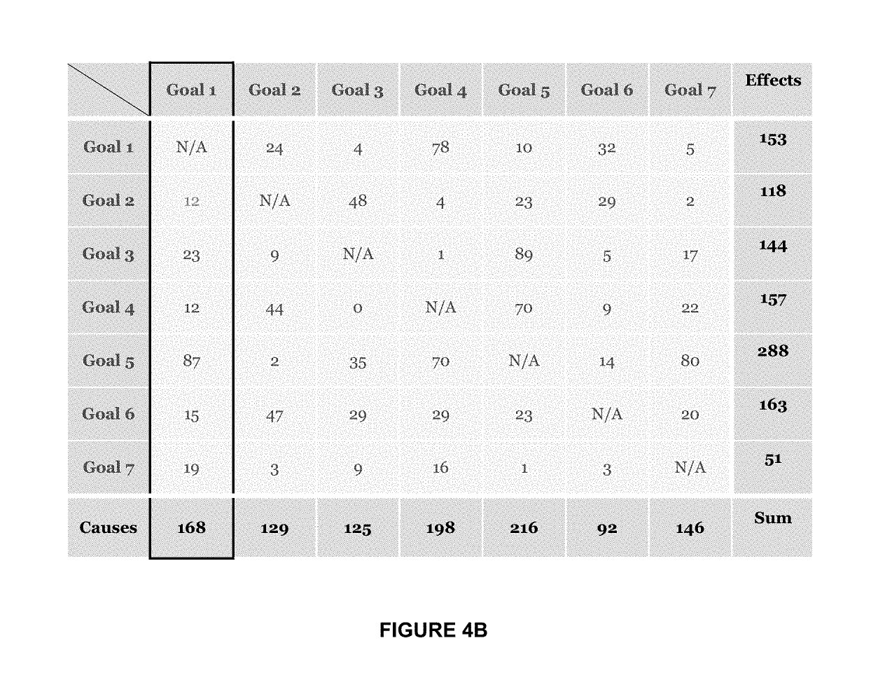

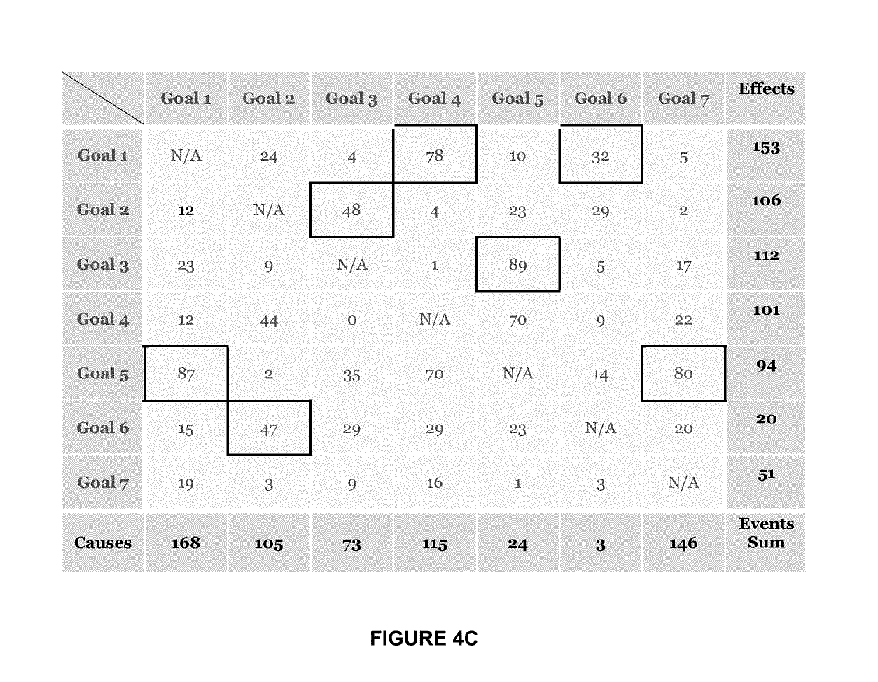

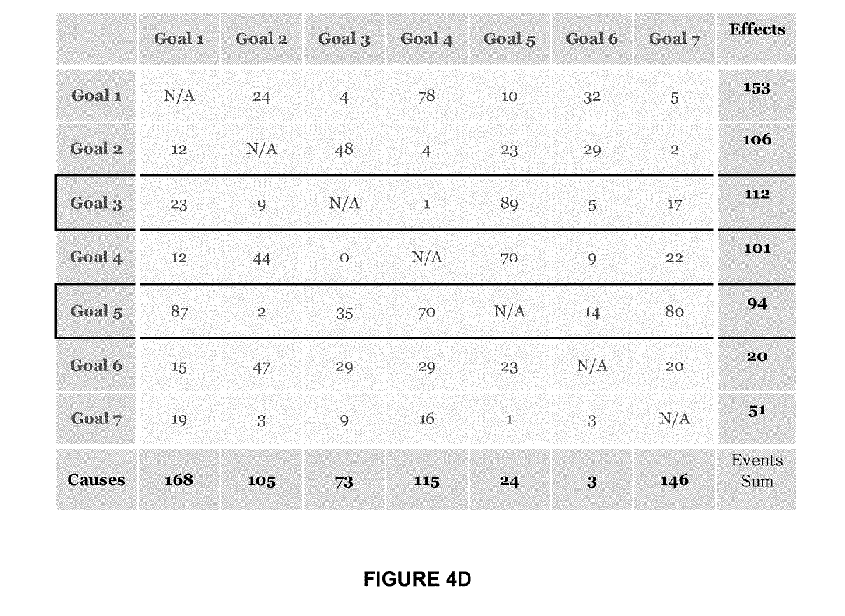

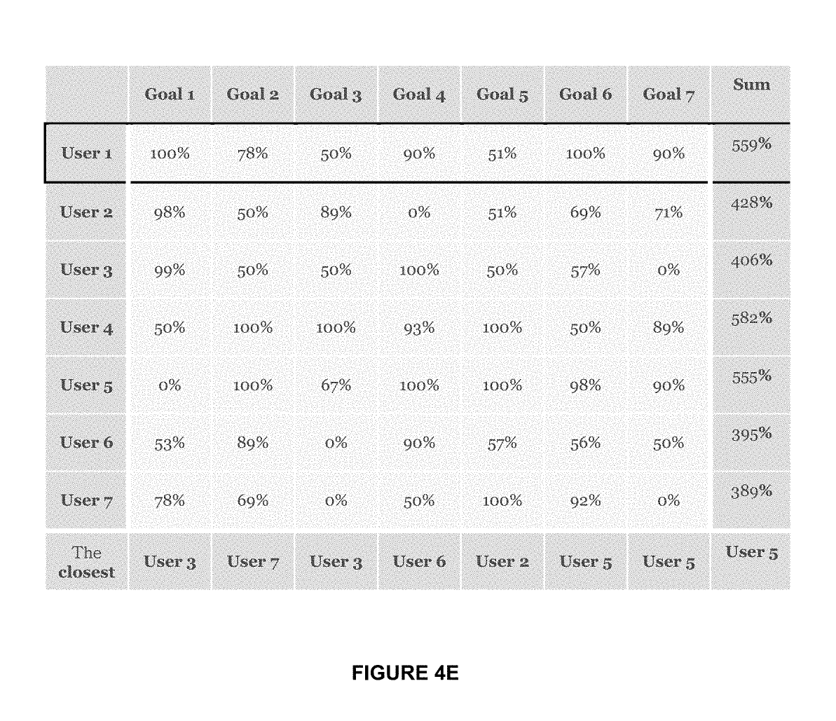

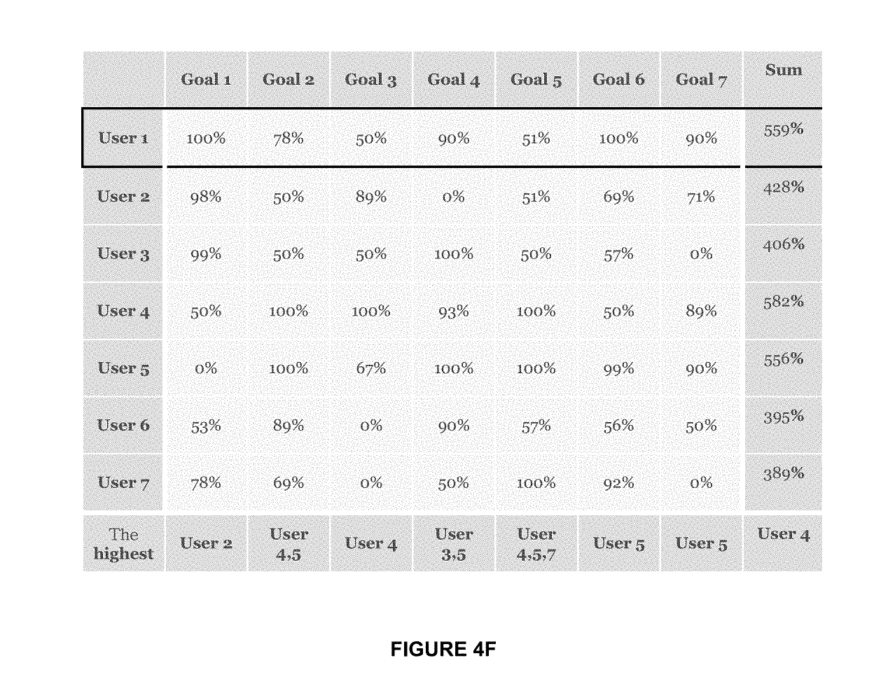

FIGS. 4A-4F illustrate state event data used for analyzing biographical information in accordance with some embodiments.

FIG. 4A illustrates state event data used in recommending one or more target state events in accordance with some embodiments.

The table shown in FIG. 4A includes multiple users (e.g., user 1 through user 7) in respective rows and multiple target state events (also called herein goals) (e.g., goal 1 through goal 7) in respective columns. User 1 has only one target state event, namely goal 1. In response to recommend one or more target state events for user 1, other users who also have goal 1 as a target state event are identified (e.g., user 2 through user 7), and target state events of the identified users are obtained (e.g., goal 2 through goal 7). From goal 2 through goal 7, goal 2 is a most popular goal among the identified users (e.g., all six users have goal 2 as a target state event). Thus, goal 2 can be recommended as a target state event to user 1. In some embodiments, multiple target state events are identified based on popularity criteria (e.g., top three most popular target state events, target state events that more than 50% of other users have, etc.). In some embodiments, a least popular target state event is recommended (e.g., goal 3).

FIG. 4B illustrates state event data used in identifying synergy state events in accordance with some embodiments.

The table shown in FIG. 4B includes multiple state events (e.g., goal 1 through goal 7) as causes in respective rows and the same state events as effects in respective columns. Each number in a box corresponding to a cause state event and an effect state event represents a frequency of transitions observed from biographical information of a large of people. For example, twelve people who achieved goal 2 subsequently achieved goal 1, twenty three people who achieved goal 3 subsequently achieved goal 1, seventy people who achieved goal 5 subsequently achieved goal 4.

Thus, for a person who wants to achieve goal 1, the table shown in FIG. 4B can be used to identify which other goals are helpful for achieving goal 1. For example, goal 5 is the most frequent cause for achieving goal 1, having eighty seven cases, and goal 2 is the least frequent cause for achieving goal 1, having only twelve cases. Alternatively, a relative importance of each other goal in achieving a particular goal can be expressed in a fraction or in percentile (e.g., a frequency divided by a sum of frequencies for a particular effect state event). For example, the synergy effect of goal 2 in achieving goal 1 can be described as 7.1% (≈12/168), and the synergy effect of goal 5 in achieving goal 1 can be described as 51.8% (≈87/168).

FIG. 4C illustrates state event data used in identifying recommended state events in accordance with some embodiments.

The table shown in FIG. 4C is similar to the table shown in FIG. 4B. From the table shown in FIG. 4C, it can be identified that, for achieving goal 1, goal 5 is the most frequent cause state event (e.g., many people who achieved goal 5 subsequently achieved goal 1). In addition, it can be identified from the table in FIG. 4C that, for achieving goal 5, goal 3 is the most frequent cause state event (e.g., many people who achieved goal 3 subsequently achieved goal 5). Similarly, goal 2 is the most frequent cause state event for goal 3, goal 6 is the most frequent cause state event for goal 2. Thus, a recommended path for achieving goal 1 starts from goal 6, followed by goal 2, goal, 3, goal 5, and goal 1.

FIG. 4D illustrates state event data used in identifying one or more probable state events in accordance with some embodiments.

The table shown in FIG. 4D is similar to the tables shown in FIGS. 4B and 4C. From the table shown in FIG. 4D, it is identified that a person having achieved goal 3 is most likely to achieve goal 5. In addition, from the table shown in FIG. 4D, it is identified that a person having achieved goal 5 is most likely to achieve goal 1. Thus, goals 1 and 5 are identified as probable state events for the person having achieved goal 3.

FIG. 4E illustrates state event data used in recommending one or more users in accordance with some embodiments.

The table shown in FIG. 4E includes multiple users (e.g., user 1 through user 7) in respective rows and multiple goals (e.g., goal 1 through goal 7) in respective columns. Each number in a box corresponding to a user row and a goal column represents how much progress a corresponding has made for achieving a corresponding goal. For example, user 1 has achieved goal 1 (represented by 100%), made 78% progress in achieving goal 2, 50% progress in achieving goal 3, etc. User 2 through user 7 are other users who also have goals that user 1 has (e.g., goal 1 through goal 7). Similarly, the progress that each other use has made for achieving the listed goals is indicated with numbers. In some embodiments, a sum of all the progress numbers for each user is used to identify recommended users. For example, user 1 has the sum of 559%. User 5 has a sum of 555%, which is a sum that is the closest to the sum of user 5, among the listed sums. Thus, user 5 is recommended to user 1 (e.g., as a study companion, etc.).

FIG. 4F illustrates state event data used in identifying one or more users in accordance with some embodiments.

The table shown in FIG. 4F is similar the table shown in FIG. 4E. From the table shown in FIG. 4F, user 4 has the highest sum. Thus, user 4 is deemed to have made the most progress for the goals that user 1 has achieved or wants to achieve, and user 4 is recommended to user 1 (e.g., as a mentor, etc.).

FIG. 5A-5E are flow diagrams illustrating a method 500 of identifying recommended state events in accordance with some embodiments.

The method 500 is performed at a computer system (e.g., data processing system 108, FIG. 2) with one or more processors and memory.

The system crawls (502) a plurality of web pages, a respective web page containing biographical information of a respective person. In some embodiments, crawling a plurality of web pages includes retrieving and storing the plurality of web pages (e.g., from data servers 104, FIG. 1). In some embodiments, the system crawls multiple web pages concurrently. For example, the data processing system 108 in FIG. 1 may retrieve one or more pages from data server 104-1 while retrieving one or more pages from data server 104-2. In some embodiments, the data processing system 108 includes dozens of servers for crawling the plurality of web pages.

The system parses (504) the crawled information into state events and determines causality between any two of the state events. For example, the system extracts educational background (e.g., educational institution, degree, and period) and/or work history (e.g., employer, title, and period) from an online biography (e.g., a LinkedIn or Facebook web page, etc.). In some embodiments, the system parses the crawled information into state events using one or more templates (e.g., a template for a LinkedIn web page). In some embodiments, the system determines a sequence of the state events, and determines causality based on the sequence of the state events. For example, in some embodiments, a first state event (also called herein a preceding state event) that precedes a second state event (also called herein a following state event) is deemed to be a cause of the second state event.

The system stores (506) the state events and the causality in a database (e.g., database 214, FIG. 2). For example, the system stores the state events in the entity information 216 and the causality in the connection information 220. In some embodiments, the system stores the state events and the causality so that the state events and the causality from one web page are aggregated with state events and causality from multiple other web pages. In some embodiments, the system stores the state events and the causality so that the state events and the causality determined from one web page can be identified separately from state events and causality determined from other web pages.

In some embodiments, the system determines connection parameters (e.g., transition parameters) based on the state events and the causality. For example, the system may count a number of transitions from State Event 1 to State Event 3 for all or a subset of data stored in the database (e.g., how many people who received a college degree in computer sciences from a particular school got a job as a software engineer at a particular company). In some embodiments, only a subset of data is used for determining the connection parameters (e.g., recent ten-year data).

Subsequent to storing the state events and the causality in the database, the system receives (508) a first request from a user to determine a path to a target state. In some embodiments, the request is sent from a client device (e.g., a laptop or a desktop) associated with the user. For example, the user may access the system using a web browser on the client device, and submit a request to determine a path to a target state (e.g., how can I become a CEO of this company?). The target state includes a target state event (e.g., a particular position at a particular company or a particular degree from a particular school).

In response to receiving the first request, the system obtains (510) a current state of the user. The current state of the user includes one or more state events associated with the user. For example, the user may submit his or her current states to the system so that the system can perform the requested operation based on the user's current states. In some embodiments, the current states represent educational background and work history to date (e.g., having received a college degree in a particular subject matter from a particular school).

The system determines (512) one or more paths from the current state of the user to the target state based on the current state of the user and the state events and the causality stored in the database, including identifying one or more recommended state events, each recommended state event of the one or more recommended state events having a causality value for the target state that satisfies first preselected causality criteria. For example, as shown in FIG. 4C, for achieving a particular goal (e.g., goal 1), goal 5 is recommended, because there are many precedents that people who have achieved goal 5 subsequently achieve goal 1. In addition, goal 3 may be also recommended, because there are many precedents that people who have achieved goal 3 subsequently achieve goal 5. In some embodiments, the first preselected causality criteria are satisfied when a recommended state event has a higher causality value than any other state event. For example, for achieving goal 1, goal 5 has the highest causality value among goal 2 through goal 7. In some embodiments, the first preselected causality criteria are satisfied when a causality value exceeds a preselected threshold (e.g., a frequency of 50 or an average of frequencies, etc.).

The system provides (514) at least one path from the current state of the user to the target state. For example, the system sends a web page that includes the one or more recommended state events to the client device associated with the user for display. In some embodiments, the at least one path includes the one or more recommended state events (e.g., “since you have achieved goal 2, you need to achieve goal 3 next and then goal 5 to achieve goal 1”).

In some embodiments, in response to receiving the first request, the system determines one or more paths to the target state based on the state events and the causality stored in the database, regardless of the current state of the user. Determining the one or more paths includes identifying one or more recommended state events, each recommended state event of the one or more recommended state events having a causality value for the target state that satisfies the first preselected causality criteria. The system provides at least one path to the target state.

In some embodiments, the one or more recommended state events are (516, FIG. 5B) one or more N-generation recommended state events. For example, goal 5 is an N generation recommended state event (e.g., −1 generation). The system repeats identifying one or more recommended state events so that one or more N−1 generation recommended state events are identified for at least one N generation recommended state event. For example, goal 3 is identified as an N−1 generation recommended state event (e.g., −2 generation). Each N−1 generation recommended state event has a causality value for the one N generation recommended state event that satisfies the first preselected causality criteria and N is reduced by a generation each time the identifying is repeated (e.g., −3 generation recommended state events are identified subsequently).

In some embodiments, the system identifies (518) one or more synergy state events. Each synergy state event of the one or more synergy state events has a relative frequency that satisfies preselected frequency criteria. The relative frequency is based on respective frequencies of transitions to the target state event from multiple state events, that have transitions to the target state event, including the synergy state event. In some embodiments, the relative frequency for a respective cause state event is a ratio between a respective frequency for a transition from the respective cause state event to the target state event and a sum of frequencies for transitions from all cause state events to the target state event. For example, as shown in FIG. 4B, a transition from goal 5 to goal 1 has a relative frequency of 51.8% (≈87/168) and a transition from goal 2 to goal 1 has a relative frequency of 7.1% (≈12/168). In some embodiments, the preselected frequency criteria are satisfied when each synergy state event of the one or more synergy state events has a relative frequency higher than a relative frequency of any other state events that have transitions to the target state event (e.g., top two state events with highest relative frequencies). In some embodiments, the preselected frequency criteria are satisfied when each synergy state event of the one or more synergy state events has a relative frequency higher than a preselected threshold (e.g., more than 10%).

In some embodiments, a synergy effect of a respective synergy state event is determined. In some embodiments, the synergy effect of the respective synergy state event is determined at least based on the relative frequency of the respective synergy state event. In some embodiments, the synergy effect of the respective synergy state event is determined also based on a degree of progress in achieving the respective synergy state event. For example, the synergy effect of the respective synergy state event is based on a multiple of the relative frequency of the respective synergy state event and the degree of progress in achieving the respective synergy state event.

In some embodiments, the system determines (520) a probability of achieving the target state from the current state of the user. In some embodiments, the probability of achieving the target state from the current state of the user is based on synergy effects of the user's existing goals and/or recommended goals. In some embodiments, the probability of achieving the target state from the current state of the user is also based on a degree of progress in achieving the target state event. In some embodiments, the probability of achieving the target state from the current state of the user is set to be no less than 50%.

In some embodiments, the system determines (522) the probability of achieving the target state from the current state of the user based on relative frequencies of the one or more synergy events.

In some embodiments, subsequent to storing the state events and the causality in the database, the system receives (524, FIG. 5C) a second request to recommend one or more target states. In response to receiving the second request, the system obtains the current state of the user. The current state of the user includes one or more state events associated with the user. The system determines one or more target states based on the current state of the user and the state events and the causality stored in the database, including identifying one or more probable state events. Each probable state event of the one or more probable state events has a causality value from the current state of the user that satisfies second preselected causality criteria. The system provides at least a subset of the one or more target states. For example, as shown in FIG. 4D, for a person having achieved goal 3, goal 5 is identified as a probable state event, because a number of transitions from goal 3 to goal 5 is high. In some cases, goal 1 is also identified as a probable state event, because once the person achieves goal 5, the person is likely to achieve goal 1. In some embodiments, the second preselected causality criteria are deemed to be satisfied in accordance with a determination that the causality value exceeds a preselected threshold. In some embodiments, the second preselected causality criteria are deemed to be satisfied in accordance with a determination that the causality value is higher than a causality value for any other transition from the current state.

In some embodiments, the one or more probable state events are (526) one or more M-generation probable state events. For example, in FIG. 4D, goal 5 is an M generation probable state event (e.g., first generation). The system repeats identifying one or more probable state events so that one or more M+1 generation probable state events are identified for at least one M generation probable state event (e.g., goal 1 is generated as a second generation probable state event). Each M+1 generation probable state event has a causality value for the one M generation probable state event that satisfies the second preselected causality criteria. M is advanced by a generation each time the identifying is repeated (e.g., after identifying a second generation probable state event, a third generation probable state event is identified).

In some embodiments, subsequent to storing the state events and the causality in the database, the system receives (528, FIG. 5D) a third request to identify one or more users. In response to receiving the third request, the system identifies one or more target state events of the user, and identifies one or more candidate users who are distinct from the user. Each candidate user of the one or more candidate users is associated with at least one target state event of the one or more target state events associated with the user. The system identifies at least a subset of the one or more candidate users based on preselected user selection criteria, and provides at least the subset of the one or more candidate users identified based on the preselected user selection criteria. For examples, as shown in FIG. 4E, persons who have the same goals as the user (e.g., user 1) are identified as candidate users. Based on the progress each person has made on those goals, one or more persons are recommended.

In some embodiments, the preselected user selection criteria require (530) that a probability of achieving a target state event, of the one or more target state events of the user, for a candidate user is higher than a probability of achieving the target state event for any other candidate user of the one or more candidate users. For example, as shown in FIG. 4F, for user 1 who wants to achieve goal 3, user 4 is identified because user 4 has the highest probability of (or the most progress in) achieving goal 3. Thus, user 4 can be recommended as a mentor to user 1 in achieving goal 3. In some embodiments, a probability of achieving the target state event is determined based on a degree of progress in achieving the target state event. In some embodiments, the degree of progress in achieving the target state event is deemed to be the probability of achieving the target state event.

In some embodiments, the preselected user selection criteria require (532) that a sum of respective probabilities of achieving respective target state events, of the one or more target state events of the user, for a candidate user is higher than a sum of respective probabilities of achieving respective target state events for any other candidate user of the one or more candidate users. For example, as shown in FIG. 4F, for user 1, user 4 is identified because user 4 has the highest sum of probabilities of achieving the target state events. Thus, user 4 can be recommended as a mentor to user 1 in achieving the target state events.

In some embodiments, the preselected user selection criteria require (534) that all of the one or more target state events of the user are associated with a candidate user as target state events of the candidate user. For example, as shown in FIG. 4F, a candidate user (e.g., user 2) has all of the target state events of user 1 (e.g., goal 1 through goal 7) as the candidate user's target state events, and user 2 is recommended as a potential friend to user 1 for having common goals.

In some embodiments, the preselected user selection criteria require that a predefined number of the one or more target state events of the user are associated with a candidate user as target state events of the candidate user.

In some embodiments, the preselected user selection criteria require (536) that a sum of respective probabilities of achieving respective target state events, of the one or more target state events of the user, by a candidate user is closer to a sum of respective probabilities of achieving the respective target state events by the user than any other candidate user of the one or more candidate users. For example, as shown in FIG. 4E, for user 1, user 5 is identified because the sum of probabilities of achieving the target state events for user 5 is the closest to the sum of probabilities of achieving the target state events for user 1.

In some embodiments, subsequent to storing the state events and the causality in the database, the system receives (538, FIG. 5E) a fourth request to recommend one or more target state events. In response to receiving the fourth request, the system identifies one or more state events of the user and identifies a plurality of related users. Each related user has at least one state event of the one or more state events of the user. The system identifies one or more recommended state events of the plurality of related users. Each recommended state event of the one or more recommended state events is not associated with the user. The system identifies at least a subset of the one or more recommended state events of the plurality of related users based on preselected recommended state event criteria, and provides at least the subset of the one or more recommended state events of the plurality of related users. For example, as shown in FIG. 4A, based on the goal of user 1 (e.g., goal 1), users who also have goal 1 are identified. Then, other goals of the identified users are identified and a most frequent goal that user 1 does not have (e.g., goal 2) is recommend to user 1. In a more specific example, for a user 1 who has a goal of receiving a degree in computer science from a particular school, the system identifies other users who also want to receive, or have received, a degree in computer science from the particular school, identify goals of the identified users, and recommend popular goals to user 1.

In some embodiments, subsequent to storing the state events and the causality in the database, the system receives (540) a fifth request to identify one or more past states; and, in response to receiving the fifth request, obtains the current state of the user. The current state of the user includes one or more state events associated with the user. The system determines one or more past states based on the current state of the user and the state events and the causality stored in the database, including identifying one or more probable past state events. Each probable past state event of the one or more probable past state events has a causality value to the current state of the user that satisfies third preselected causality criteria. The system provides at least a subset of the one or more past states. For example, as shown in FIG. 4B, when the user 1 has achieved goal 1, the most likely cause state event (e.g., goal 5) is identified as a past event, because the transition from goal 5 to goal 1 has a highest occurrence among all possible transitions to goal 1. In some embodiments, the third preselected causality criteria are deemed to be satisfied in accordance with a determination that the causality value exceeds a preset threshold. In some embodiments, the third preselected causality criteria are deemed to be satisfied in accordance with a determination that the causality value is more than a causality value for a transition from any other state event to the current state.

In some embodiments, the one or more probable past state events are (542) one or more P-generation probable past state events. For example, goal 5 is identified as a −1 generation probable past state event. The system repeats identifying one or more probable past state events so that one or more P−1 generation probable past state events are identified for at least one P generation probable past state event. For example, goal 3 is identified as a −2 generation probable past state event, because the transition from goal 3 to goal 5 has a highest occurrence among all possible transitions to goal 5. Each P−1 generation probable past state event has a causality value to the one P generation probable past state event that satisfies the third preselected causality criteria and P is reduced by a generation each time the identifying is repeated.

In some embodiments, the system receives multiple requests concurrently and respond to the multiple requests concurrently. For example, the system receives tens of requests, retrieves information from the database, processes the requests, and provides results.

In some embodiments, a respective request (e.g., the first request, the second request, the third request, the fourth request, the fifth request, etc.) is transmitted as an electrical signal or an optical signal.

In some embodiments, some of the operations described herein are performed independent of a human intervention. For example, calculations and determinations are made without a manual input of a user (other than initiating a request).

FIG. 6A is a schematic diagram illustrating a method for forming a two-dimensional sequence table in accordance with some embodiments.

An upper portion of FIG. 6A illustrates sequential events (e.g., 1st decision A, 2nd decision B, 3rd decision C, and 4th decision D) made by a particular user. For example, the 1st decision A may correspond to a college that the particular user decided to attend, the 2nd decision B may correspond to a major that the particular user decided to study, the 3rd decision C may correspond to a first job of the particular user, and the 4th decision D may correspond to a second job of the particular user.

A lower portion of FIG. 6A illustrates a two-dimensional sequence table showing frequency of a particular pair of a preceding event and a subsequent event. For example, from a given dataset, one person made Decision A, followed by Decision B; 8 people made Decision A, followed by Decision C; and 4 people made Decision A, followed by Decision D.

One method of forming the two-dimensional sequence table is to go through a list of events for one person, identify a sequence of events, retrieve a previous frequency of a corresponding pair of a preceding event and a subsequent event, increase the frequency by one, and store the increased frequency for the pair of the preceding event and the subsequent event. For example, from the sequential events illustrated in the upper portion of FIG. 6A, Decision B is found to be subsequent to Decision A. Thus, a frequency of a pair of a preceding event A (corresponding to Decision A) and a subsequent event B (corresponding to Decision B) is retrieved (e.g., the frequency is 0) from the two-dimensional sequence table, the retrieved frequency is increased by one (for the user whose events are illustrated in the upper portion of FIG. 6A), and the increased frequency (e.g., 1) is stored in the two-dimensional sequence table. Similarly, a frequency of a preceding event A and a subsequent event C (corresponding to Decision C) is retrieved (e.g., the frequency is 7) from the two-dimensional sequence table, the retrieved frequency is increased by one, and the increased frequency (e.g., 8) is stored in the two-dimensional sequence table. This process is repeated for each occurrence of a pair of a preceding event and a subsequent event, which require a significant amount of resources and can be time-consuming. In particular, this method is not suitable for real-time response when a large amount of data is used (e.g., when a data set includes more than 100 million entries).

FIGS. 6B-6F illustrate a method for forming a linear sequence table in accordance with some embodiments.

FIG. 6B shows a linear table, where each row of the linear table corresponds to a single event. The linear table also includes information identifying a user (or a person) associated with the event. For example, the first row of the linear table in FIG. 6B includes information identifying a first event and information identifying User 1, who is associated with the first event (e.g., User 1 made a decision corresponding to Event 1, such as attending a particular college), and the second row of the linear table in FIG. 6B includes information identifying a second event and information identifying User 1, who is associated with the second event. The fifth row of the linear table in FIG. 6B includes information identifying a first event and information identifying User 2, who is associated with the first event (e.g., User 2 also made a decision corresponding to Event 1, such as attending the same college as User 1). In some embodiments, information identifying the first event includes a name of the college (e.g., Georgetown), and/or information identifying the second event includes a major or a field of study (e.g., chemistry).

FIG. 6C shows that a column is added to the linear table illustrated in FIG. 6B to form a first table. The information in the added column identifies a sequence of a corresponding event among the events associated with a particular user. For example, FIG. 6C shows that User 1 is associated with four events (e.g., Event 1, Event 2, Event 3, and Event 4). Sequence 1-1 for Event 1 includes information identifying that Event 1 is a first event among the four events associated with User 1 (e.g., Event 1 occurred first among the four events), sequence 1-2 for Event 2 includes information identifying that Event 2 is a second event among the four events (e.g., Event 2 occurred second among the four events), sequence 1-3 for Event 3 includes information identifying that Event 3 is a third event among the four events (e.g., Event 3 occurred third among the four events), and sequence 1-4 for Event 4 includes information identifying that Event 4 is a fourth (and last) event among the four events (e.g., Event 4 occurred fourth among the four events). Similarly, sequence 2-1 for Event 1 includes information identifying that Event 1 is a first event among events associated with User 2.

Although the first table shown in FIG. 6C is described as created by adding a column to the table shown in FIG. 6B, the first table shown in FIG. 6C can be generated by creating a new three column table and filling in with information from the table shown in FIG. 6B.

In FIG. 6D, a second table that corresponds to the first table shown in FIG. 6C is used. In some embodiments, the second table is identical to the first table shown in FIG. 6C. In some embodiments, the second table is a mirror image of the first table shown in FIG. 6C, as illustrated in FIG. 6D.

FIG. 6E shows that the first table and the second table are joined based on a selective matching. In joining the first table and the second table, each row of the first table and each row of the second table are joined together when both correspond to a same user and an event of a corresponding row in the first table occurred before an event of a corresponding row in the second table (e.g., an event of a corresponding row in the second table occurred after an event of a corresponding row in the first table). For example, as shown in FIG. 6E, the first row of the joined table includes information from the first row of the first table (corresponding to Event 1 associated with User 1) and the second row of the second table (corresponding to Event 2 associated with User 1, which occurred after Event 1); the second row of the joined table includes information from the first row of the first table and the third row of the second table (corresponding to Event 3 associated with User 1, which occurred after Event 1); the third row of the joined table includes information from the first row of the first table and the fourth row of the second table (corresponding to Event 4 associated with User 1, which occurred after Event 1); the fourth row of the joined table includes information from the second row of the first table (corresponding to Event 2 associated with User 1) and the third row of the second table (corresponding to Event 3 associated with User 1, which occurred after Event 2); the fifth row of the joined table includes information from the second row of the first table (corresponding to Event 2) and the fourth row of the second table (corresponding to Event 4 associated with User 1, which occurred after Event 4); and the sixth row of the joined table includes information from the third row of the first table (corresponding to Event 3 associated with User 1) and the fourth row of the second table (corresponding to Event 4 associated with User 1, which occurred after Event 3). In FIG. 6E, the seventh row of the joined table includes information from the fifth row of the first table (corresponding to Event 1 associated with User 2) and a different row of the second table (corresponding to Event 2 associated with User 2, which occurred after Event 1 for User 2). As a result, the joined table includes, in each row, a pair of a preceding event and a subsequent event for a respective user. Thus, the joined table shown in FIG. 6E is a type of a linear sequence table.

FIG. 6F illustrates that, in some embodiments, information identifying users is removed. This facilitates protecting the privacy of users. In addition, this reduces the size of the table, which makes storage and access of the information faster and easier. In FIG. 6F, information identifying the sequence (e.g., Seq 1-1, Seq 1-2, etc.) is also removed. Even without the information identifying the sequence, the relative sequence between a preceding event and a subsequent event can be identified based on corresponding locations in the table.

FIG. 6G illustrates a multi-dimensional sequence table formed from a linear sequence table in accordance with some embodiments.

From the linear sequence table shown in FIG. 6F, entries are selectively grouped, aggregated, counted, and/or summed to form the multi-dimensional sequence table shown in FIG. 6G. For example, from the linear sequence table, all entries that have Event 1 (e.g., Event A) as a preceding event and Event 2 (e.g., Event B) as a subsequent event are identified and counted. The count is stored in the multi-dimensional sequence table at a corresponding location. This process is repeated for multiple pairs of preceding events and subsequent events. The selective grouping, aggregation, counting, and/or summing are performed by a database instruction (or a set of database instructions), which can be performed in parallel. In addition, the selective grouping, aggregation, counting, and/or summing reduce the number of times a corresponding database has to be accessed, because multiple data entries can be retrieved or stored concurrently. Thus, the use of the linear sequence table in forming the multi-dimensional sequence table can be significantly faster than the method described with respect to FIG. 6A. In some cases, the use of the linear sequence table is faster enough so that the linear sequence table can be directly used without forming a multi-dimensional sequence table.

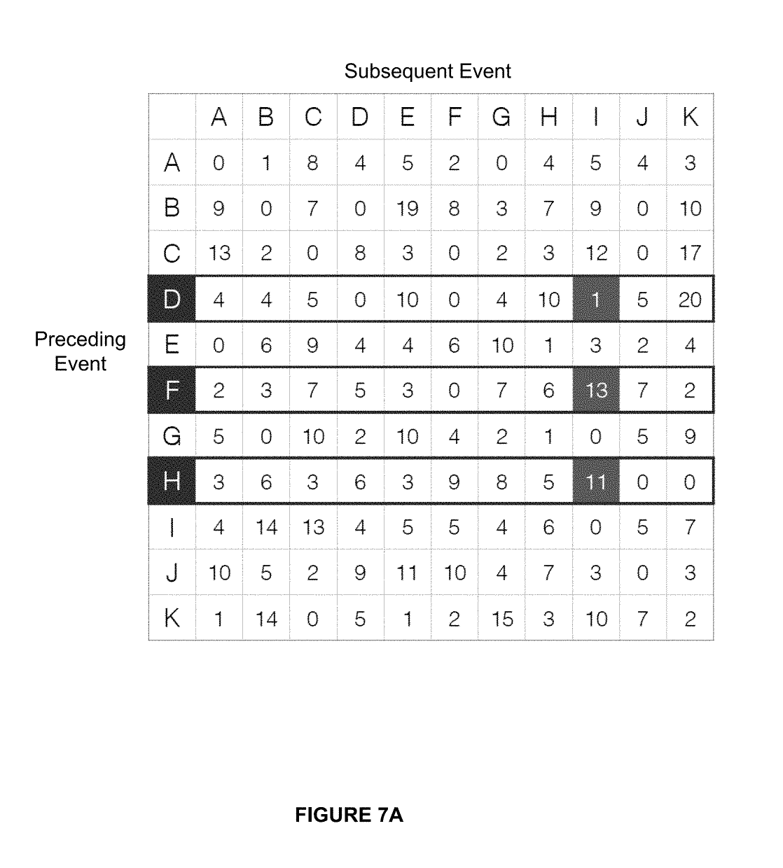

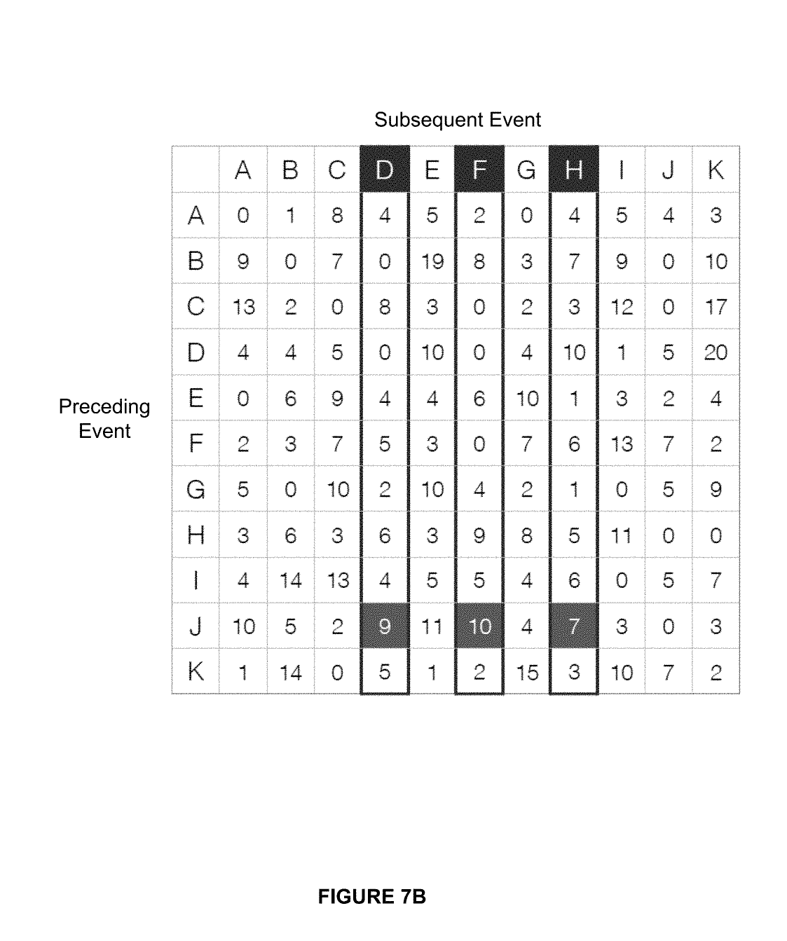

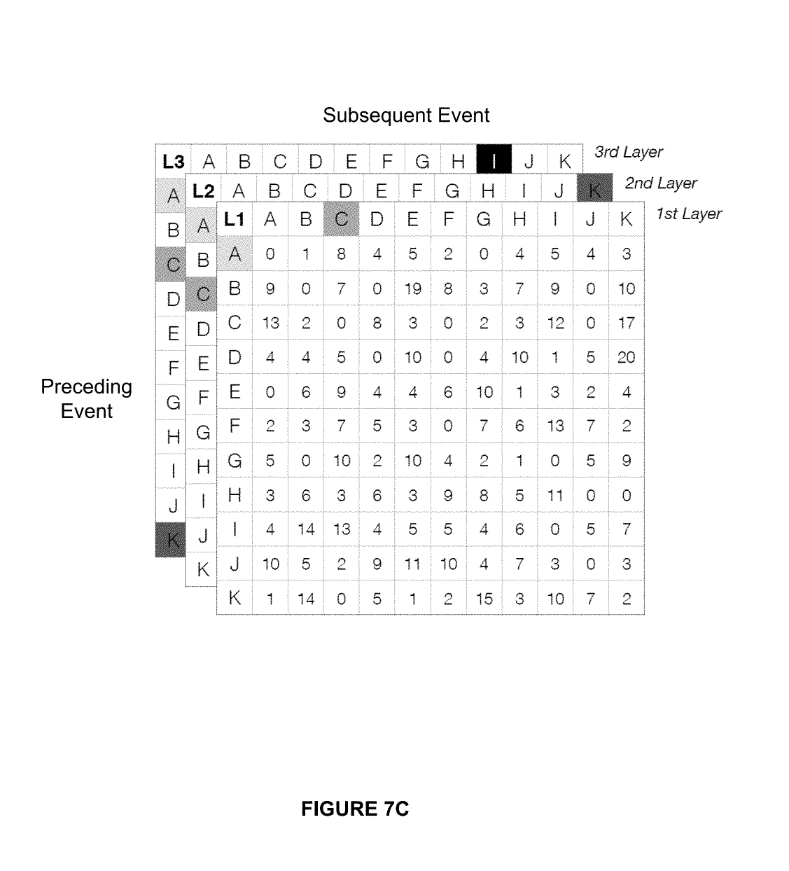

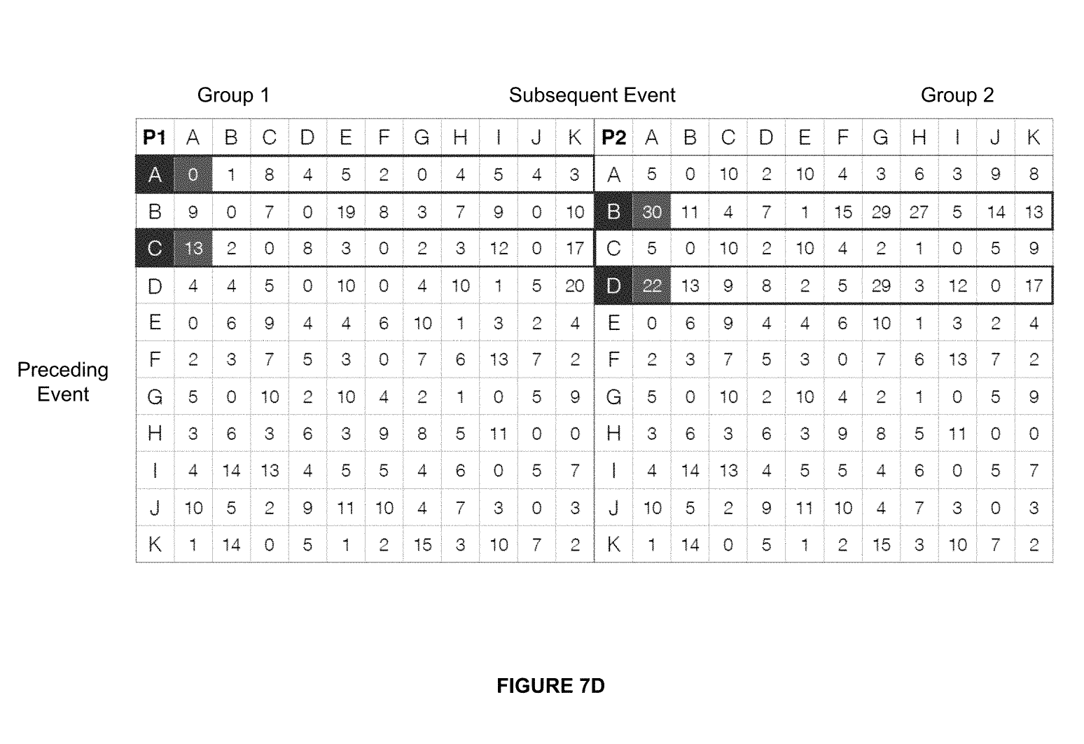

FIGS. 7A-7D illustrate methods for using sequence information in accordance with some embodiments.

FIG. 7A illustrates that, for a set of preceding events, a subsequent event with a highest frequency (or a highest sum of frequencies) is selected. For example, for preceding events D, F, and H, a subsequent event I has a highest sum of frequencies (e.g., 25, which is a sum of 1, 13, and 11). Thus, in accordance with a determination that preceding events D, F, and H have occurred, event I is selected as a most likely subsequent event.

FIG. 7B illustrates that, for a set of subsequent events, a preceding event with a highest frequency (or a highest sum of frequencies) is selected. For example, for subsequent events, D, F, and H, a preceding event J has a highest sum of frequencies (e.g., 26, which is a sum of 9, 10, and 7). Thus, in accordance with a determination that subsequence events D, F, and H have occurred, event J is selected as a most likely preceding event.

FIG. 7C illustrates a deep searching method using the multi-dimensional sequence table. First, in accordance with a determination that event A has occurred, event C is selected as a most likely subsequent event. Second, in accordance with a determination that event

A and event C would have occurred, event K is selected as a most likely next subsequent event. Thereafter, in accordance with a determination that event A, C, and K would like occurred, event I is selected as a most likely next subsequent event. This process can be repeated to determine likely (or recommended) subsequent events (e.g., decisions).

FIG. 7D illustrates that two multi-dimensional sequence tables are used. The left hand side of FIG. 7D shows a two-dimensional sequence table for Group 1 (e.g., a first group of users), and the right hand side of FIG. 7D shows a two-dimensional sequence table for Group 2 (e.g., a second group of users that is distinct from the first group of users). When preceding events A and C have occurred for Group 1, and preceding events B and D have occurred for Group 2, event A is selected as a subsequent event with a highest sum of frequencies. Thus, event A is most likely to occur for both Groups 1 and 2 (e.g., event A has already occurred for Group 1, and event A is likely to occur for Group 2).

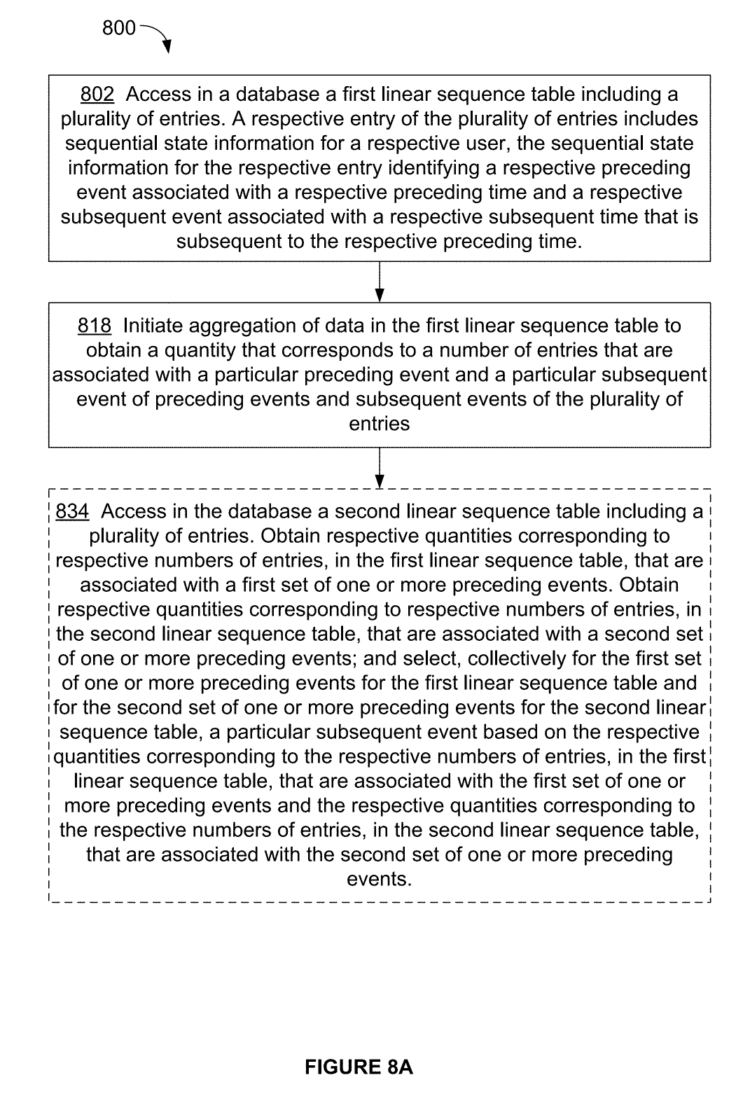

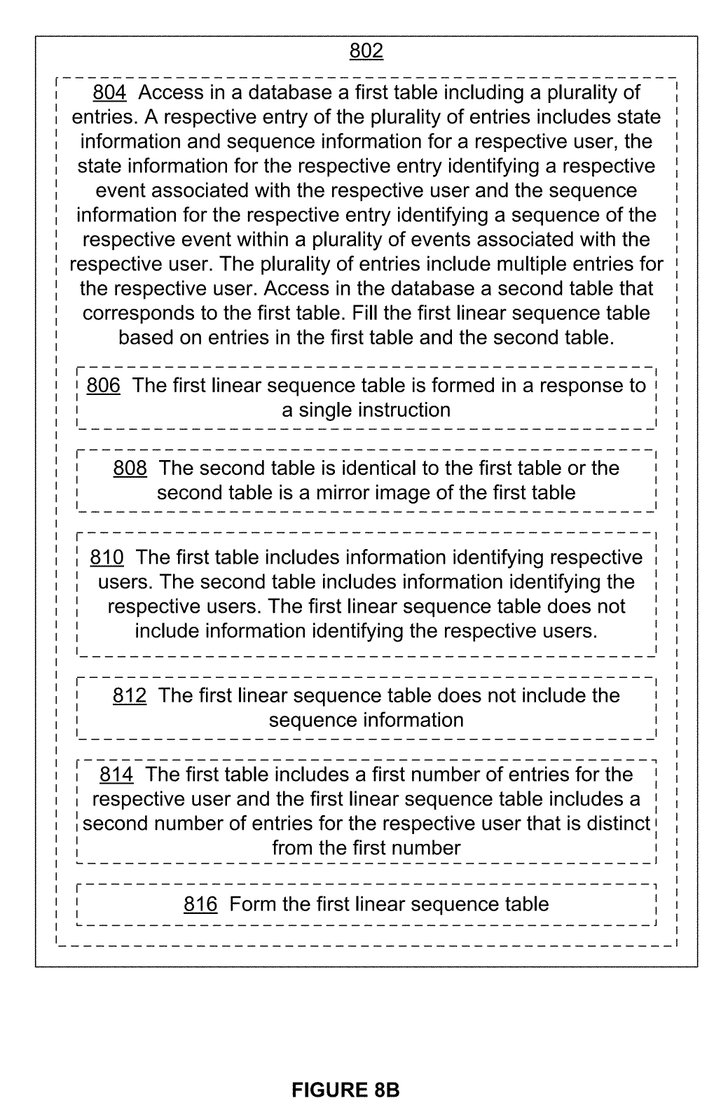

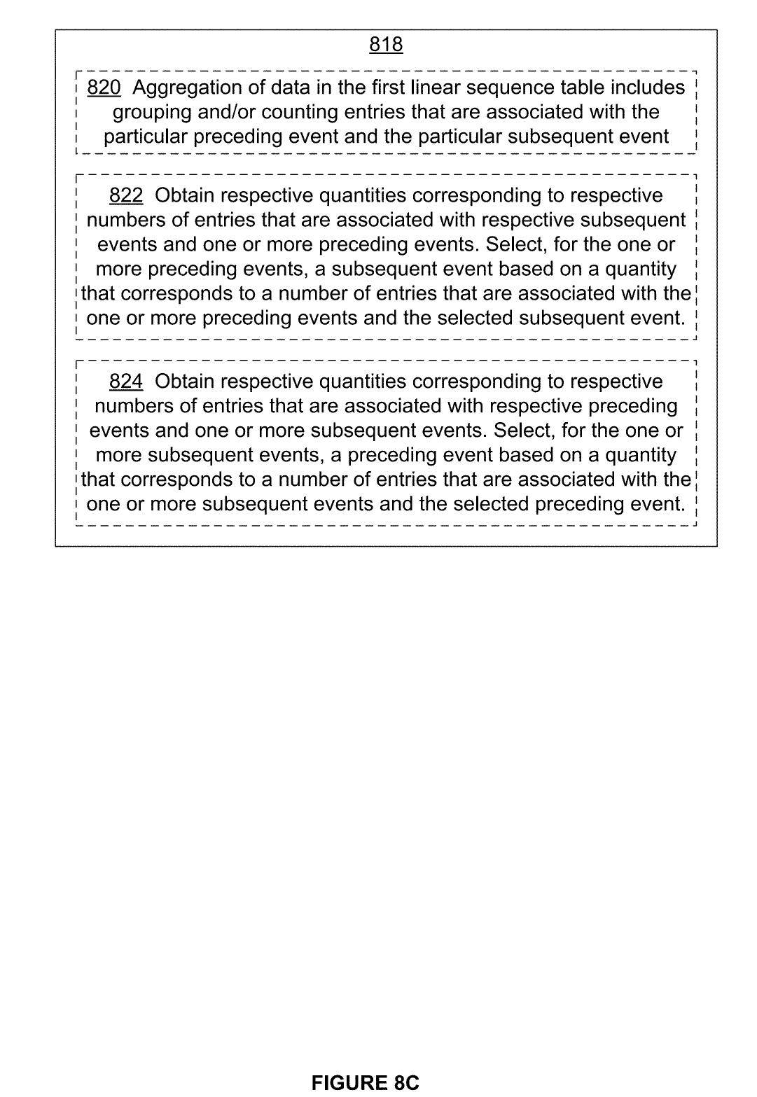

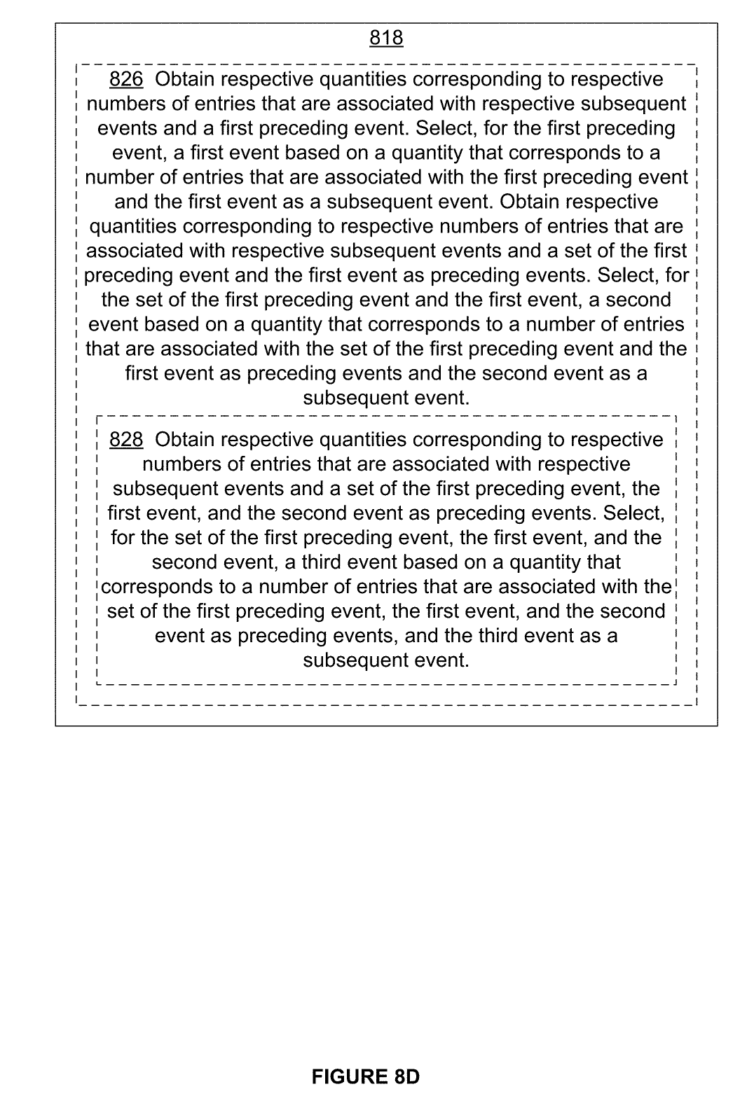

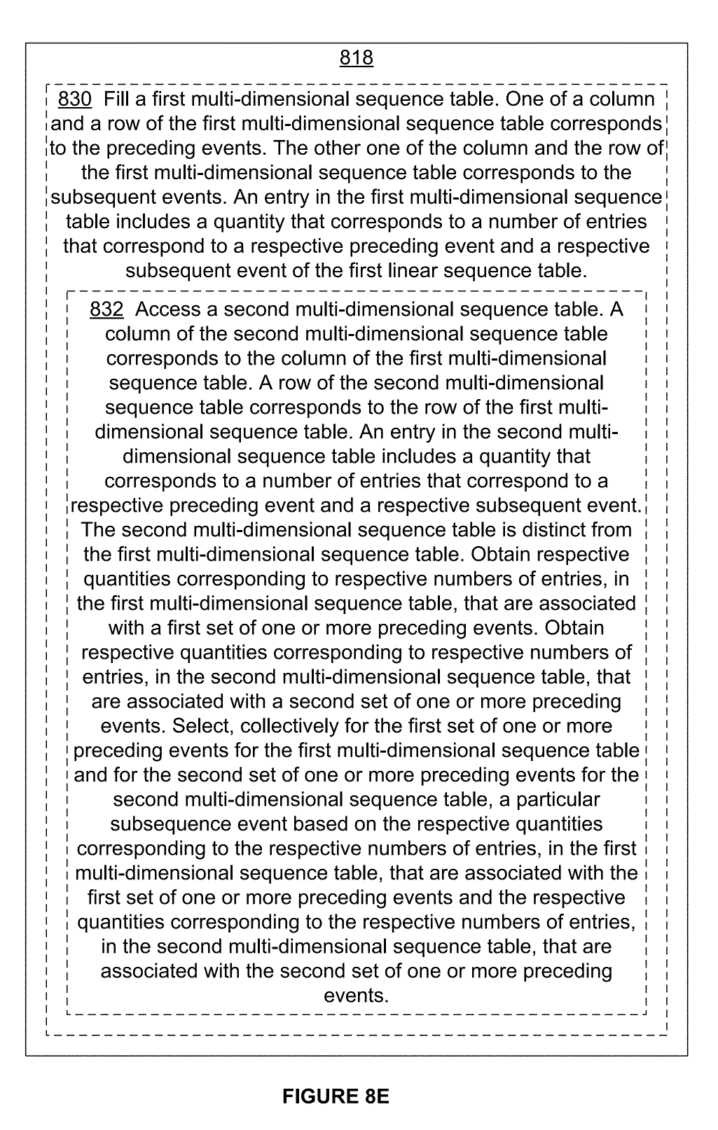

FIG. 8A-8E are flow diagrams illustrating a method 800 of processing big data in accordance with some embodiments.

The method 800 is performed at a computer system (e.g., the data processing system 108 in FIG. 2) with one or more processors and memory.

The method includes (802) accessing in a database a first linear sequence table including a plurality of entries (e.g., the linear sequence table shown in FIG. 6F). A respective entry of the plurality of entries includes sequential state information for a respective user, the sequential state information for the respective entry identifying a respective preceding event associated with a respective preceding time and a respective subsequent event associated with a respective subsequent time that is subsequent to the respective preceding time.

In some embodiments, the method includes (804, FIG. 8B) accessing in a database a first table including a plurality of entries (e.g., the table shown in FIG. 6C). A respective entry of the plurality of entries includes state information and sequence information for a respective user, the state information for the respective entry identifying a respective event associated with the respective user and the sequence information for the respective entry identifying a sequence of the respective event within a plurality of events associated with the respective user. The plurality of entries includes multiple entries for the respective user. The method also includes accessing in the database a second table that corresponds to the first table (e.g., the second table shown in FIG. 6D); and filling the first linear sequence table based on entries in the first table and the second table (e.g., the table shown in FIG. 6E).

In some embodiments, the first linear sequence table is formed (806) in response to a single instruction (e.g., a JOIN command in SQL). In some embodiments, the first linear sequence table is formed in response to a single set of instructions.

In some embodiments, the second table is (808) identical to the first table or the second table is a mirror image of the first table (e.g., FIG. 6D).

In some embodiments, the first table includes (810) information identifying respective users; the second table includes information identifying the respective users; and the first linear sequence table does not include information identifying the respective users. For example, the tables in FIG. 6D include information identifying respective users, and the table in 6F does not include information identifying the respective users. This helps protecting the privacy of users.

In some embodiments, the first linear sequence table does not include (812) the sequence information (e.g., the table shown in FIG. 6F).

In some embodiments, the first table includes (814) a first number of entries for the respective user and the first linear sequence table includes a second number of entries for the respective user that is distinct from the first number (e.g., the table in FIG. 6C has 4 entries for User 1 and the table in FIG. 6E has 6 entries for User 1).

In some embodiments, the method also includes (816) forming the first linear sequence table (e.g., FIG. 6F).

The method also includes (818, FIG. 8A) initiating aggregation of data in the first linear sequence table to obtain a quantity that corresponds to a number of entries that are associated with a particular preceding event and a particular subsequent event of preceding events and subsequent events of the plurality of entries. For example, the entries in the linear sequence table shown in FIGS. 6F are selectively aggregated (e.g., using a GROUP command in SQL).

In some embodiments, aggregation of data in the first linear sequence table includes (820, FIG. 8C) grouping and/or counting entries that are associated with the particular preceding event and the particular subsequent event (e.g., entries that are associated with the particular preceding event and the particular subsequent event are counted).

In some embodiments, the method includes (822) obtaining respective quantities corresponding to respective numbers of entries that are associated with respective subsequent events and one or more preceding events; and selecting, for the one or more preceding events, a subsequent event based on a quantity that corresponds to a number of entries that are associated with the one or more preceding events and the selected subsequent event (e.g., FIG. 7A).

In some embodiments, the method includes (824) obtaining respective quantities corresponding to respective numbers of entries that are associated with respective preceding events and one or more subsequent events; and selecting, for the one or more subsequent events, a preceding event based on a quantity that corresponds to a number of entries that are associated with the one or more subsequent events and the selected preceding event (e.g., FIG. 7B).

In some embodiments, the method includes (826, FIG. 8D) obtaining respective quantities corresponding to respective numbers of entries that are associated with respective subsequent events and a first preceding event; selecting, for the first preceding event, a first event based on a quantity that corresponds to a number of entries that are associated with the first preceding event and the first event as a subsequent event; obtaining respective quantities corresponding to respective numbers of entries that are associated with respective subsequent events and a set of the first preceding event and the first event as preceding events; and selecting, for the set of the first preceding event and the first event, a second event based on a quantity that corresponds to a number of entries that are associated with the set of the first preceding event and the first event as preceding events and the second event as a subsequent event (e.g., in FIG. 7C, event K is selected as a subsequent event for events A and C as preceding events).

In some embodiments, the method also includes (828) obtaining respective quantities corresponding to respective numbers of entries that are associated with respective subsequent events and a set of the first preceding event, the first event, and the second event as preceding events; and selecting, for the set of the first preceding event, the first event, and the second event, a third event based on a quantity that corresponds to a number of entries that are associated with the set of the first preceding event, the first event, and the second event as preceding events, and the third event as a subsequent event (e.g., in FIG. 7C, event I is selected as a subsequent event for events A, C, and K as preceding events).

In some embodiments, the method includes (830) filling a first multi-dimensional sequence table (e.g., FIG. 6G). One of a column and a row of the first multi-dimensional sequence table corresponds to the preceding events. The other one of the column and the row of the first multi-dimensional sequence table corresponds to the subsequent events. An entry in the first multi-dimensional sequence table includes a quantity that corresponds to a number of entries that correspond to a respective preceding event and a respective subsequent event of the first linear sequence table.

In some embodiments, the method includes (832) accessing a second multi-dimensional sequence table (e.g., FIG. 7D). A column of the second multi-dimensional sequence table corresponds to the column of the first multi-dimensional sequence table. A row of the second multi-dimensional sequence table corresponds to the row of the first multi-dimensional sequence table. An entry in the second multi-dimensional sequence table includes a quantity that corresponds to a number of entries that correspond to a respective preceding event and a respective subsequent event. The second multi-dimensional sequence table is distinct from the first multi-dimensional sequence table. The method also includes obtaining respective quantities corresponding to respective numbers of entries, in the first multi-dimensional sequence table, that are associated with a first set of one or more preceding events; obtaining respective quantities corresponding to respective numbers of entries, in the second multi-dimensional sequence table, that are associated with a second set of one or more preceding events; and selecting, collectively for the first set of one or more preceding events for the first multi-dimensional sequence table and for the second set of one or more preceding events for the second multi-dimensional sequence table, a particular subsequence event based on the respective quantities corresponding to the respective numbers of entries, in the first multi-dimensional sequence table, that are associated with the first set of one or more preceding events and the respective quantities corresponding to the respective numbers of entries, in the second multi-dimensional sequence table, that are associated with the second set of one or more preceding events.

In some embodiments, the method also includes (834, FIG. 8A) accessing in the database a second linear sequence table including a plurality of entries. A respective entry of the plurality of entries includes sequential state information for a respective user, the sequential state information for the respective entry identifying a respective preceding event associated with a respective preceding time and a respective subsequent event associated with a respective subsequent time that is subsequent to the respective preceding time. The method further includes initiating aggregation of data in the second linear sequence table to obtain a quantity that corresponds to a number of entries that are associated with a particular preceding event and a particular subsequent event of preceding events and subsequent events of the plurality of entries; obtaining respective quantities corresponding to respective numbers of entries, in the first linear sequence table, that are associated with a first set of one or more preceding events; obtaining respective quantities corresponding to respective numbers of entries, in the second linear sequence table, that are associated with a second set of one or more preceding events; and selecting, collectively for the first set of one or more preceding events for the first linear sequence table and for the second set of one or more preceding events for the second linear sequence table, a particular subsequent event based on the respective quantities corresponding to the respective numbers of entries, in the first linear sequence table, that are associated with the first set of one or more preceding events and the respective quantities corresponding to the respective numbers of entries, in the second linear sequence table, that are associated with the second set of one or more preceding events. For example, the results obtained by the operation 832 can be obtained without using the multi-dimensional sequence tables.

In some embodiments, the method includes providing (e.g., displaying) information identifying one or more selected events (e.g., one or more selected subsequence events and/or one or more selected preceding events).

Several features described with respect to FIGS. 4A-4F and 5A-5E are also applicable to the method 800 described with respect to FIGS. 8A-8E. For example, the methods of using sequential state events described with respect to FIGS. 4A-4F and 5A-5E can be performed with sequential state information in linear sequence tables or multi-dimensional sequence tables described with respect to FIGS. 6H, 7A-7D and 8A-8E. For brevity, these details are not repeated herein.

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings.

For example, in some embodiments, a computer system with one or more processors and memory accesses in a database a first table including a plurality of entries. A respective entry of the plurality of entries includes state information and sequence information for a respective user. The state information for the respective entry identifies a respective event associated with the respective user and the sequence information for the respective entry identifying a sequence of the respective event within a plurality of events associated with the respective user. The plurality of entries includes multiple entries for the respective user. The computer system accesses in the database a second table that corresponds to the first table, and fills a first linear sequence table based on entries in the first table and the second table. The first linear sequence table includes a plurality of entries. A respective entry of the plurality of entries of the first linear sequence table includes sequential state information for a particular user. The sequential state information for the respective entry identifies a respective preceding event associated with a respective preceding time and a respective subsequent event associated with a respective subsequent time that is subsequent to the respective preceding time. The computer system initiates aggregation of data in the first linear sequence table to obtain a quantity that corresponds to a number of users who are associated with a particular preceding event and a particular subsequent event.

The embodiments were chosen and described in order to best explain the underlying principles and their practical applications, to thereby enable others skilled in the art to best utilize the described principles and various embodiments with various modifications as are suited to the particular use contemplated.

What is claimed is:

1. A method for processing big data, comprising:
at a computer system with one or more processors and memory:
accessing in a database a first linear sequence table including a plurality of entries, wherein a respective entry of the plurality of entries includes sequential state information for a respective user, the sequential state information for the respective entry identifying a respective preceding event associated with a respective preceding time and a respective subsequent event associated with a respective subsequent time that is subsequent to the respective preceding time; and
initiating aggregation of data in the first linear sequence table to obtain a quantity that corresponds to a number of entries that are associated with a particular preceding event and a particular subsequent event of preceding events and subsequent events of the plurality of entries.

2. The method of claim 1, wherein:
aggregation of data in the first linear sequence table includes grouping and/or counting entries that are associated with the particular preceding event and the particular subsequent event.

3. The method of claim 1, comprising:
accessing in a database a first table including a plurality of entries, wherein:
a respective entry of the plurality of entries includes state information and sequence information for a respective user, the state information for the respective entry identifying a respective event associated with the respective user and the sequence information for the respective entry identifying a sequence of the respective event within a plurality of events associated with the respective user; and
the plurality of entries includes multiple entries for the respective user;
accessing in the database a second table that corresponds to the first table; and
filling the first linear sequence table based on entries in the first table and the second table.

4. The method of claim 3, wherein the first linear sequence table is formed in response to a single instruction.

5. The method of claim 3, wherein the second table is identical to the first table or the second table is a mirror image of the first table.

6. The method of claim 3, wherein the first table includes information identifying respective users; the second table includes information identifying the respective users; and the first linear sequence table does not include information identifying the respective users.

7. The method of claim 3, wherein the first linear sequence table does not include the sequence information.

8. The method of claim 3, wherein the first table includes a first number of entries for the respective user and the first linear sequence table includes a second number of entries for the respective user that is distinct from the first number.

9. The method of claim 3, further comprising forming the first linear sequence table.

10. The method of claim 1, further comprising:
obtaining respective quantities corresponding to respective numbers of entries that are associated with respective subsequent events and one or more preceding events; and
selecting, for the one or more preceding events, a subsequent event based on a quantity that corresponds to a number of entries that are associated with the one or more preceding events and the selected subsequent event.

11. The method of claim 1, further comprising:
obtaining respective quantities corresponding to respective numbers of entries that are associated with respective preceding events and one or more subsequent events; and
selecting, for the one or more subsequent events, a preceding event based on a quantity that corresponds to a number of entries that are associated with the one or more subsequent events and the selected preceding event.

12. The method of claim 1, further comprising:
obtaining respective quantities corresponding to respective numbers of entries that are associated with respective subsequent events and a first preceding event;
selecting, for the first preceding event, a first event based on a quantity that corresponds to a number of entries that are associated with the first preceding event and the first event as a subsequent event;
obtaining respective quantities corresponding to respective numbers of entries that are associated with respective subsequent events and a set of the first preceding event and the first event as preceding events; and
selecting, for the set of the first preceding event and the first event, a second event based on a quantity that corresponds to a number of entries that are associated with the set of the first preceding event and the first event as preceding events and the second event as a subsequent event.

13. The method of claim 12, further comprising:
obtaining respective quantities corresponding to respective numbers of entries that are associated with respective subsequent events and a set of the first preceding event, the first event, and the second event as preceding events; and
selecting, for the set of the first preceding event, the first event, and the second event, a third event based on a quantity that corresponds to a number of entries that are associated with the set of the first preceding event, the first event, and the second event as preceding events, and the third event as a subsequent event.

14. The method of claim 1, further comprising:
filling a first multi-dimensional sequence table, wherein:
one of a column and a row of the first multi-dimensional sequence table corresponds to the preceding events;
the other one of the column and the row of the first multi-dimensional sequence table corresponds to the subsequent events; and
an entry in the first multi-dimensional sequence table includes a quantity that corresponds to a number of entries that correspond to a respective preceding event and a respective subsequent event of the first linear sequence table.

15. The method of claim 14, further comprising:
accessing a second multi-dimensional sequence table, wherein:
a column of the second multi-dimensional sequence table corresponds to the column of the first multi-dimensional sequence table;
a row of the second multi-dimensional sequence table corresponds to the row of the first multi-dimensional sequence table;
an entry in the second multi-dimensional sequence table includes a quantity that corresponds to a number of entries that correspond to a respective preceding event and a respective subsequent event; and
the second multi-dimensional sequence table is distinct from the first multi-dimensional sequence table; and
obtaining respective quantities corresponding to respective numbers of entries, in the first multi-dimensional sequence table, that are associated with a first set of one or more preceding events;
obtaining respective quantities corresponding to respective numbers of entries, in the second multi-dimensional sequence table, that are associated with a second set of one or more preceding events; and
selecting, collectively for the first set of one or more preceding events for the first multi-dimensional sequence table and for the second set of one or more preceding events for the second multi-dimensional sequence table, a particular subsequence event based on the respective quantities corresponding to the respective numbers of entries, in the first multi-dimensional sequence table, that are associated with the first set of one or more preceding events and the respective quantities corresponding to the respective numbers of entries, in the second multi-dimensional sequence table, that are associated with the second set of one or more preceding events.

16. The method of claim 1, further comprising:
accessing in the database a second linear sequence table including a plurality of entries, wherein a respective entry of the plurality of entries includes sequential state information for a respective user, the sequential state information for the respective entry identifying a respective preceding event associated with a respective preceding time and a respective subsequent event associated with a respective subsequent time that is subsequent to the respective preceding time;
initiating aggregation of data in the second linear sequence table to obtain a quantity that corresponds to a number of entries that are associated with a particular preceding event and a particular subsequent event of preceding events and subsequent events of the plurality of entries;
obtaining respective quantities corresponding to respective numbers of entries, in the first linear sequence table, that are associated with a first set of one or more preceding events;
obtaining respective quantities corresponding to respective numbers of entries, in the second linear sequence table, that are associated with a second set of one or more preceding events; and
selecting, collectively for the first set of one or more preceding events for the first linear sequence table and for the second set of one or more preceding events for the second linear sequence table, a particular subsequent event based on the respective quantities corresponding to the respective numbers of entries, in the first linear sequence table, that are associated with the first set of one or more preceding events and the respective quantities corresponding to the respective numbers of entries, in the second linear sequence table, that are associated with the second set of one or more preceding events.

17. A computer system, comprising:
one or more processors; and
memory storing one or more programs, which, when executed by the one or more processors, cause the computer system to:
access in a database a first linear sequence table including a plurality of entries, wherein a respective entry of the plurality of entries includes sequential state information for a respective user, the sequential state information for the respective entry identifying a respective preceding event associated with a respective preceding time and a respective subsequent event associated with a respective subsequent time that is subsequent to the respective preceding time; and
initiate aggregation of data in the first linear sequence table to obtain a quantity that corresponds to a number of entries that are associated with a particular preceding event and a particular subsequent event of preceding events and subsequent events of the plurality of entries.

18. A computer readable storage medium, storing one or more programs for execution by one or more processors of a computer system, the one or more programs including instructions for:
accessing in a database a first linear sequence table including a plurality of entries, wherein a respective entry of the plurality of entries includes sequential state information for a respective user, the sequential state information for the respective entry identifying a respective preceding event associated with a respective preceding time and a respective subsequent event associated with a respective subsequent time that is subsequent to the respective preceding time; and
initiating aggregation of data in the first linear sequence table to obtain a quantity that corresponds to a number of entries that are associated with a particular preceding event and a particular subsequent event of preceding events and subsequent events of the plurality of entries.
